(19) United States
(12) Patent Application Publication
(10) Pub. No.: US 2025/0092487 A1
(43) Pub. Date: Mar. 20, 2025

(54) METHODS FOR LIBERATING PRECIOUS METALS USING A REAGENT HAVING A THIOCARBONYL FUNCTIONAL GROUP

(71) Applicant: Jetti Resources, LLC, Boulder, CO (US)

(72) Inventors: Zihe Ren, Richmond (CA); Nelson Mora Huertas, Boulder, CO (US); David Dixon, Delta (CA); Edouard Asselin, Richmond (CA); Ahmad Ghahreman, Kingston (CA)

(73) Assignee: Jetti Resources, LLC, Boulder, CO (US)

(21) Appl. No.: 18/562,228

(22) PCT Filed: May 16, 2022
(86) PCT No.: PCT/US2022/029445

§ 371 Date: Nov. 17, 2023

Related U.S. Application Data
(60) Provisional application No. 63/189,649, filed on May 17, 2021.

(51) Int. Cl. C22B 11/00; C22B 3/08; C22B 3/18; C22B 3/22

(52) U.S. Cl. CPC C22B 11/04; C22B 3/08; C22B 3/18; C22B 3/22

(57) ABSTRACT

The present disclosure relates to a method using a reagent having a thiocarbonyl functional group to liberate a precious metal such as gold from a material comprising a sulfide, wherein the sulfide encapsulates the precious metal. Such a method comprises contacting the material under acidic conditions with the reagent comprising the thiocarbonyl functional group and optionally producing a residue comprising the precious metal. The present disclosure also relates to the use of a reagent having a thiocarbonyl functional group in methods for extracting a precious metal from a material comprising a sulfide, wherein the sulfide encapsulates the precious metal, the method comprising leaching the precious metal from a residue comprising the precious metal produced from such a method for liberating a precious metal.

### CROSS-REFERENCE TO RELATED APPLICATIONS

This application claims the benefit of U.S. Provisional Application No. 63/189,649, filed May 17, 2021, the disclosure of which is incorporated herein by reference.

### FIELD

The present disclosure relates to the use of a reagent having a thiocarbonyl functional group, for example, in a method for liberating a precious metal from a material, wherein the material comprises a sulfide encapsulating the precious metal, and optionally extracting the precious metal.

### BACKGROUND

High grade, easy-to-leach gold deposits have been rapidly depleted over the past decades. A significant amount of current gold deposits are found in ores that are resistant to gold recovery by traditional leaching methods. Examples of leaching-resistant gold ores are ores comprising fine particles of the gold encapsulated in sulfide matrices. For example, pyrite (FeS₂) is a common sulfide mineral in such refractory gold deposits and is one of the most inert metal sulfides. Arsenic bearing pyrite (arsenian pyrite) is another of the main gold-bearing pyrite ores. Arsenopyrite (FeAsS) is also one of the main gold-bearing sulfide minerals.

Gold-bearing sulfide minerals resistant to leaching are often collectively referred to as refractory sulfide ores. Pre-treatment processes have been used to liberate gold particles from such refractory sulfide ores prior to subsequent recovery via traditional methods such as cyanidation. A widely used pre-treatment technique is roasting, which has been applied to flotation concentrates for decades. However, in addition to being capital-intensive, roasting can release toxic gases and/or generate other undesirable byproducts. Other conventional pre-treatment methods include chlorination, pressure oxidation, ultrafine grinding and floatation-intensive leaching. However, such methods have disadvantages such as high reagent cost, low gold recovery and/or environmental risks. Bio-oxidation pre-treatment methods are also known, but conventional bio-oxidation methods have low processing speed.

Thiocarbonyl compounds such as thiourea (Tu) and ethylene thiourea have been shown to catalyze the extraction of base metals such as copper from materials such as sulfide ores and have demonstrated good compatibility with bacteria commonly used in bio-leaching such as Acidithiobacillus ferrooxidans. Tu has also been reported as a lixiviant in precious metal leaching where ferric ion is used as an oxidant and Tu is used as a complexing agent. Tu has been reported to act on gold as a lixiviant according to the formula:

$${Au}^{0} + 2 {CS ( {NH}_{2} )}_{2} ⇌ {Au [ {CS ( {NH}_{2} )}_{2} ]}_{{2}^{+}} + {e}^{-} .$$

### SUMMARY

The present disclosure includes a method and use of a reagent having a thiocarbonyl functional group for the liberation of precious metals from materials comprising a sulfide, wherein the sulfide encapsulates the precious metal. Following such use of a reagent having a thiocarbonyl functional group, the precious metals can then be extracted, for example, using traditional methods such as cyanidation. The use of a reagent having a thiocarbonyl functional group for liberating precious metals is a pre-treatment performed, for example, before extraction. Traditional extraction methods in combination with the methods and uses comprising the liberation of precious metals using a reagent having a thiocarbonyl functional group yields greater precious metal recovery than the corresponding traditional extraction methods alone.

Accordingly, the present disclosure includes a method for liberating a precious metal from a material, the method comprising: contacting the material under acidic conditions with a reagent having a thiocarbonyl functional group, wherein the material comprises a sulfide encapsulating the precious metal.

In an embodiment, the material is contacted with the reagent having the thiocarbonyl functional group by a method comprising: contacting the material with an acidic mixture comprising the reagent having the thiocarbonyl functional group.

In an embodiment, the reagent having the thiocarbonyl functional group is added to the method in monomeric form. In another embodiment, the reagent having the thiocarbonyl functional group is devoid of thiourea. In another embodiment, the reagent having the thiocarbonyl functional group is N—N′ substituted thioureas; 2,5-dithiobiurea; dithiobiuret; thiosemicarbazide purum; thiosemicarbazide; thioacetamide; 2-methyl-3-thiosemicarbazide; 4-methyl-3-thiosemicarbazide; vinylene trithiocarbonate purum; vinylene trithiocarbonate; 2-cyanothioacetamide; ethylene trithiocarbonate; potassium ethyl xanthogenate; dimethylthiocarbamoyl chloride; dimethyldithiocarbamate; dimethyl trithiocarbonate; N,N-dimethylthioformamide; 4,4-dimethyl-3-thiosemicarbazide; 4-ethyl-3-thiosemicarbazide; O-isopropylxanthic acid; ethyl thiooxamate; ethyl dithioacetate; pyrazine-2-thiocarboxamide; diethylthiocarbamoyl chloride; diethyldithiocarbamate; tetramethylthiuram monosulfide; tetramethylthiuram disulfide; pentafluorophenyl chlorothionoformate; 4-fluorophenyl chlorothionoformate; O-phenyl chlorothionoformate; phenyl chlorodithioformate; 3,4-difluorothiobenzamide; 2-bromothiobenzamide; 3-bromothiobenzamide; 4-bromothiobenzamide; 4-chlorothiobenzamide; 4-fluorothiobenzamide; thiobenzoic acid; thiobenzamide; 4-phenylthiosemicarbazide; O-(p-tolyl) chlorothionoformate; 4-bromo-2-methylthiobenzamide; 3-methoxythiobenzamide; 4-methoxythiobenzamide; 4-methylbenzenethioamide; thioacetanilide; salicylaldehyde thiosemicarbazone; indole-3-thiocarboxamide; S-(thiobenzoyl)thioglycolic acid; 3-(acetoxy)thiobenzamide; 4-(acetoxy)thiobenzamide; methyl N′-[(e)-(4-chlorophenyl)methylidene]hydrazonothiocarbamate; 3-ethoxythiobenzamide; 4-ethylbenzene-1-thiocarboxamide; tert-butyl 3-[(methylsulfonyl)oxy]-1-azetanecarboxylate; diethyldithiocarbamic acid; 2-(phenylcarbonothioylthio)propanoic acid; 2-hydroxybenzaldehyde N-ethylthiosemicarbazone; (1R,4R)-1,7,7-trimethylbicyclo[2.2.1]heptane-2-thione; tetraethylthiuram disulfide; 4′-hydroxybiphenyl-4-thiocarboxamide; 4-biphenylthioamide; dithizone; 4′-methylbiphenyl-4-thiocarboxamide; tetraisopropylthiuram disulfide; anthracene-9-thiocarboxamide; phenanthrene-9-thiocarboxamide; sodium dibenzyldithiocarbamate; 4,4′-bis(dimethylamino)thiobenzophenone; or any combination thereof. In another embodiment, the reagent having the thiocarbonyl functional group comprises thiourea, ethylene thiourea, thioacetamide, sodium dimethyldithiocarbamate, ethylene trithiocarbonate, thiosemicarbazide or combinations thereof. In another embodiment, the reagent having the thiocarbonyl functional group comprises thiourea. In another embodiment, the reagent having the thiocarbonyl functional group is thiourea (Tu). In another embodiment, the reagent having the thiocarbonyl functional group is added to the method in the form of the corresponding dimer. In another embodiment, the reagent having the thiocarbonyl functional group is thioacetamide (TA). In another embodiment, the reagent having the thiocarbonyl functional group is sodium-dimethyldithiocarbamate (SDDC). In another embodiment, the reagent having the thiocarbonyl functional group is ethylene trithiocarbonate (ETC). In another embodiment, the reagent having the thiocarbonyl functional group is thiosemicarbazide (TSCA).

In an embodiment, the reagent having the thiocarbonyl functional group is present in the acidic conditions at a concentration of about 50 mM or lower. In another embodiment, the reagent having the thiocarbonyl functional group is present in the acidic conditions at a concentration of about 0.002 mM to about 50 mM. In another embodiment, the reagent having the thiocarbonyl functional group is present in the acidic conditions at a concentration of about 0.002 mM to about 30 mM. In another embodiment, the reagent having the thiocarbonyl functional group is present in the acidic conditions at a concentration of about 0.002 mM to about 20 mM. In another embodiment, the reagent having the thiocarbonyl functional group is present in the acidic conditions at a concentration of about 0.002 mM to about 10 mM. In another embodiment, the reagent having the thiocarbonyl functional group is present in the acidic conditions at a concentration of about 0.002 mM to about 5 mM. In another embodiment, the reagent having the thiocarbonyl functional group is present in the acidic conditions at a concentration of about 0.002 mM to about 2 mM. In another embodiment, the reagent having the thiocarbonyl functional group is present in the acidic conditions at a concentration of about 0.002 mM to about 1 mM. In another embodiment, the reagent having the thiocarbonyl functional group is present in the acidic conditions at a concentration of about 0.002 mM to about 0.2 mM. In another embodiment, the reagent having the thiocarbonyl functional group is present in the acidic conditions at a concentration of about 0.002 mM to about 0.02 mM. In another embodiment, the reagent having the thiocarbonyl functional group is present in the acidic conditions at a concentration of about 0.02 mM to about 50 mM. In another embodiment, the reagent having the thiocarbonyl functional group is present in the acidic conditions at a concentration of about 0.02 mM to about 30 mM. In another embodiment, the reagent having the thiocarbonyl functional group is present in the acidic conditions at a concentration of about 0.02 mM to about 20 mM. In another embodiment, the reagent having the thiocarbonyl functional group is present in the acidic conditions at a concentration of about 0.02 mM to about 10 mM. In another embodiment, the reagent having the thiocarbonyl functional group is present in the acidic conditions at a concentration of about 0.02 mM to about 5 mM. In another embodiment, the reagent having the thiocarbonyl functional group is present in the acidic conditions at a concentration of about 0.02 mM to about 2 mM. In another embodiment, the reagent having the thiocarbonyl functional group is present in the acidic conditions at a concentration of about 0.02 mM to about 1 mM. In another embodiment, the reagent having the thiocarbonyl functional group is present in the acidic conditions at a concentration of about 0.02 mM to about 0.2 mM. In another embodiment, the reagent having the thiocarbonyl functional group is present in the acidic conditions at a concentration of about 0.2 mM to about 50 mM. In another embodiment, the reagent having the thiocarbonyl functional group is present in the acidic conditions at a concentration of about 0.2 mM to about 30 mM. In another embodiment, the reagent having the thiocarbonyl functional group is present in the acidic conditions at a concentration of about 0.2 mM to about 20 mM. In another embodiment, the reagent having the thiocarbonyl functional group is present in the acidic conditions at a concentration of about 0.2 mM to about 10 mM. In another embodiment, the reagent having the thiocarbonyl functional group is present in the acidic conditions at a concentration of about 0.2 mM to about 5 mM. In another embodiment, the reagent having the thiocarbonyl functional group is present in the acidic conditions at a concentration of about 0.2 mM to about 2 mM. In another embodiment, the reagent having the thiocarbonyl functional group is present in the acidic conditions at a concentration of about 0.2 mM to about 1 mM.

The present disclosure also includes a method for liberating a precious metal from a material, the method comprising: contacting the material under acidic conditions with formamidine disulfide (FDS), wherein the material comprises a sulfide encapsulating the precious metal. In an embodiment, the material is contacted with the FDS by a method comprising: contacting the material with an acidic mixture comprising the FDS.

In an embodiment, the FDS is present in the acidic conditions at a concentration of about 25 mM or lower. In another embodiment, the FDS is present in the acidic conditions at a concentration of about 0.001 mM to about 25 mM. In another embodiment, the FDS is present in the acidic conditions at a concentration of about 0.001 mM to about 15 mM. In another embodiment, the FDS is present in the acidic conditions at a concentration of about 0.001 mM to about 10 mM. In another embodiment, the FDS is present in the acidic conditions at a concentration of about 0.001 mM to about 5 mM. In another embodiment, the FDS is present in the acidic conditions at a concentration of about 0.001 mM to about 2.5 mM. In another embodiment, the FDS is present in the acidic conditions at a concentration of about 0.001 mM to about 1 mM. In another embodiment, the FDS is present in the acidic conditions at a concentration of about 0.001 mM to about 0.5 mM. In another embodiment, the FDS is present in the acidic conditions at a concentration of about 0.001 mM to about 0.1 mM. In another embodiment, the FDS is present in the acidic conditions at a concentration of about 0.001 mM to about 0.01 mM. In another embodiment, the FDS is present in the acidic conditions at a concentration of about 0.01 mM to about 25 mM. In another embodiment, the FDS is present in the acidic conditions at a concentration of about 0.01 mM to about 15 mM. In another embodiment, the FDS is present in the acidic conditions at a concentration of about 0.01 mM to about 10 mM. In another embodiment, the FDS is present in the acidic conditions at a concentration of about 0.01 mM to about 5 mM. In another embodiment, the FDS is present in the acidic conditions at a concentration of about 0.01 mM to about 2.5 mM. In another embodiment, the FDS is present in the acidic conditions at a concentration of about 0.01 mM to about 1 mM. In another embodiment, the FDS is present in the acidic conditions at a concentration of about 0.01 mM to about 0.5 mM. In another embodiment, the FDS is present in the acidic conditions at a concentration of about 0.01 mM to about 0.1 mM. In another embodiment, the FDS is present in the acidic conditions at a concentration of about 0.1 mM to about 25 mM. In another embodiment, the FDS is present in the acidic conditions at a concentration of about 0.1 mM to about 15 mM. In another embodiment, the FDS is present in the acidic conditions at a concentration of about 0.1 mM to about 10 mM. In another embodiment, the FDS is present in the acidic conditions at a concentration of about 0.1 mM to about 5 mM. In another embodiment, the FDS is present in the acidic conditions at a concentration of about 0.1 mM to about 2.5 mM. In another embodiment, the FDS is present in the acidic conditions at a concentration of about 0.1 mM to about 1 mM. In another embodiment, the FDS is present in the acidic conditions at a concentration of about 0.1 mM to about 0.5 mM.

In an embodiment, the material is agglomerated prior to contact.

In an embodiment, the acidic conditions further comprise an oxidizing agent. In another embodiment, the oxidizing agent comprises ferric sulfate.

In an embodiment, during the contact, the method further comprises bio-oxidation of the material. In another embodiment, the material further comprises sulfur-oxidizing bacteria, iron-oxidizing bacteria, bacteria that are sulfur-oxidizing and iron-oxidizing or combinations thereof. In another embodiment, the acidic mixture further comprises sulfur-oxidizing bacteria, iron-oxidizing bacteria, bacteria that are sulfur-oxidizing and iron-oxidizing or combinations thereof. In another embodiment, the bacteria are sulfur-oxidizing. In another embodiment, the bacteria are iron-oxidizing. In another embodiment, the bacteria are sulfur-oxidizing and iron-oxidizing.

In an embodiment, the sulfide comprises a sulfide mineral. In another embodiment, the sulfide comprises sulfur, iron, arsenic, antimony or combinations thereof. In another embodiment, the sulfide comprises sulfur. In another embodiment, the sulfide comprises iron. In another embodiment, the sulfide comprises arsenic. In another embodiment, the sulfide comprises antimony. In another embodiment, the sulfide comprises pyrite, arsenian pyrite, marcasite, arsenopyrite, pyrrhotite, enargite, bornite, chalcopyrite or combinations thereof. In another embodiment, the sulfide comprises pyrite. In another embodiment, the sulfide comprises arsenian pyrite. In another embodiment, the sulfide comprises marcasite. In another embodiment, the sulfide comprises arsenopyrite. In another embodiment, the sulfide comprises pyrrhotite. In another embodiment, the sulfide comprises enargite. In another embodiment, the sulfide comprises bornite. In another embodiment, the sulfide comprises chalcopyrite. In another embodiment, the sulfide comprises pyrite, arsenian pyrite, arsenopyrite or combinations thereof.

In an embodiment, the precious metal comprises a platinum group metal, gold, silver or combinations thereof. In another embodiment, the precious metal comprises gold. In another embodiment, the precious metal comprises silver. In another embodiment, the precious metal comprises a platinum group metal. In another embodiment, the precious metal comprises platinum. In another embodiment, the precious metal comprises gold, silver or combinations thereof.

In an embodiment, the material further comprises a base metal.

In an embodiment, the method comprises adding an acid to obtain the acidic conditions. In another embodiment, the acid comprises sulfuric acid.

In an embodiment, pH of the acidic conditions is in a range of from about 0 to about 6.5. In another embodiment, the pH of the acidic conditions is about 2.

In an embodiment, the contacting comprises a method comprising a percolation, a tank, a vat or combinations thereof. In another embodiment, the contacting comprises a method comprising a percolation. In another embodiment, the method comprising a percolation is a method comprising a heap or a dump. In another embodiment, the percolation comprises a heap. In another embodiment, the percolation comprises a dump. In another embodiment, the contacting comprises a method comprising a tank. In another embodiment, the contacting comprises a method comprising a vat.

In an embodiment, the contacting produces a residue comprising the precious metal. In another embodiment, subsequent to contact, the method further comprises pressure oxidation to produce a residue comprising the precious metal.

The present disclosure also includes a method for extracting a precious metal from a material comprising a sulfide encapsulating the precious metal, the method comprising a method as described herein for liberating a precious metal from a material, wherein the material comprises a sulfide encapsulating the precious metal, the method comprising contacting the material under acidic conditions with a reagent having a thiocarbonyl functional group wherein the contacting produces a residue comprising the precious metal; and leaching the precious metal from the residue comprising the precious metal.

In an embodiment, the leaching comprises contacting the residue with a lixiviant to extract the precious metal from the residue. In another embodiment, the lixiviant comprises cyanide, thiosulfate, glycine, thiocyanate, chloride, a reagent having a thiocarbonyl functional group or iodine/iodide. In another embodiment, the leaching comprises cyanidation. In another embodiment, the lixiviant comprises a reagent having a thiocarbonyl functional group.

In an embodiment, prior to leaching, the method further comprises washing the residue comprising the precious metal.

In an embodiment, the leaching is carried out in a method comprising a percolation leach, a tank leach, a vat leach or combinations thereof. In another embodiment, the percolation leach is a heap leach or a dump leach. In another embodiment, the leaching is carried out in a method comprising a tank leach.

In an embodiment, the method further comprises recovering the precious metal. In an embodiment, the leaching produces a pregnant leach solution comprising the precious metal and the method further comprises recovering the precious metal from the pregnant leach solution. In another embodiment, the recovering comprises cementation, ion exchange, adsorption of the precious metal on carbon, reduction of the precious metal with a reducing agent, solvent extraction or recovering, electrowinning or combinations thereof. In an embodiment, prior to the recovering, the method further comprises a solid-liquid separation.

In an embodiment, the method further comprises recovering the reagent having the thiocarbonyl functional group or the FDS. In another embodiment, the method further comprises recycling the recovered reagent having the thiocarbonyl functional group or FDS for use in the contacting of a further portion of the material and/or a further portion of the residue.

In an embodiment, the contact is at ambient temperature and pressure. In another embodiment, the contact is at ambient temperature. In another embodiment, the contact is at ambient pressure.

In an embodiment, the method is a batch method.

In an embodiment, the method is a continuous method.

The present disclosure also includes a use of a reagent having a thiocarbonyl functional group in a method for liberating a precious metal from a material, wherein the material comprises a sulfide encapsulating the precious metal. In an embodiment, the method is any method for liberating a precious metal from a material, comprising contacting the material under acidic conditions with the reagent having a thiocarbonyl functional group as described herein.

The present disclosure also includes a use of formamidine disulfide (FDS) in a method for liberating a precious metal from a material, wherein the material comprises a sulfide encapsulating the precious metal. In an embodiment, the method is any method for liberating a precious metal from a material, comprising contacting the material under acidic conditions with the formamidine disulfide (FDS) as described herein.

The present disclosure also includes a use of a reagent having a thiocarbonyl functional group for liberating a precious metal from a material, wherein the material comprises a sulfide encapsulating the precious metal; and wherein the material is contacted under acidic conditions with the reagent having the thiocarbonyl functional group.

In an embodiment, the material is contacted with the reagent having the thiocarbonyl functional group by a method comprising: contacting the material with an acidic mixture comprising the reagent having the thiocarbonyl functional group.

In an embodiment, the reagent having the thiocarbonyl functional group is added in monomeric form. In another embodiment, the reagent having the thiocarbonyl functional group is devoid of thiourea. In another embodiment, the reagent having the thiocarbonyl functional group is N—N′ substituted thioureas; 2,5-dithiobiurea; dithiobiuret; thiosemicarbazide purum; thiosemicarbazide; thioacetamide; 2-methyl-3-thiosemicarbazide; 4-methyl-3-thiosemicarbazide; vinylene trithiocarbonate purum; vinylene trithiocarbonate; 2-cyanothioacetamide; ethylene trithiocarbonate; potassium ethyl xanthogenate; dimethylthiocarbamoyl chloride; dimethyldithiocarbamate; dimethyl trithiocarbonate; N,N-dimethylthioformamide; 4,4-dimethyl-3-thiosemicarbazide; 4-ethyl-3-thiosemicarbazide; O-isopropylxanthic acid; ethyl thiooxamate; ethyl dithioacetate; pyrazine-2-thiocarboxamide; diethylthiocarbamoyl chloride; diethyldithiocarbamate; tetramethylthiuram monosulfide; tetramethylthiuram disulfide; pentafluorophenyl chlorothionoformate; 4-fluorophenyl chlorothionoformate; O-phenyl chlorothionoformate; phenyl chlorodithioformate; 3,4-difluorothiobenzamide; 2-bromothiobenzamide; 3-bromothiobenzamide; 4-bromothiobenzamide; 4-chlorothiobenzamide; 4-fluorothiobenzamide; thiobenzoic acid; thiobenzamide; 4-phenylthiosemicarbazide; O-(p-tolyl) chlorothionoformate; 4-bromo-2-methylthiobenzamide; 3-methoxythiobenzamide; 4-methoxythiobenzamide; 4-methylbenzenethioamide; thioacetanilide; salicylaldehyde thiosemicarbazone; indole-3-thiocarboxamide; S-(thiobenzoyl)thioglycolic acid; 3-(acetoxy)thiobenzamide; 4-(acetoxy)thiobenzamide; methyl N′-[(e)-(4-chlorophenyl)methylidene]hydrazonothiocarbamate; 3-ethoxythiobenzamide; 4-ethylbenzene-1-thiocarboxamide; tert-butyl 3-[(methylsulfonyl)oxy]-1-azetanecarboxylate; diethyldithiocarbamic acid; 2-(phenylcarbonothioylthio)propanoic acid; 2-hydroxybenzaldehyde N-ethylthiosemicarbazone; (1R,4R)-1,7,7-trimethylbicyclo[2.2.1]heptane-2-thione; tetraethylthiuram disulfide; 4′-hydroxybiphenyl-4-thiocarboxamide; 4-biphenylthioamide; dithizone; 4′-methylbiphenyl-4-thiocarboxamide; tetraisopropylthiuram disulfide; anthracene-9-thiocarboxamide; phenanthrene-9-thiocarboxamide; sodium dibenzyldithiocarbamate; 4,4′-bis(dimethylamino)thiobenzophenone; or any combination thereof. In another embodiment, the reagent having the thiocarbonyl functional group comprises thiourea, ethylene thiourea, thioacetamide, sodium dimethyldithiocarbamate, ethylene trithiocarbonate, thiosemicarbazide or combinations thereof. In another embodiment, the reagent having the thiocarbonyl functional group comprises thiourea. In another embodiment, the reagent having the thiocarbonyl functional group is thiourea (Tu). In another embodiment, the reagent having the thiocarbonyl functional group is added in the form of the corresponding dimer. In another embodiment, the reagent having the thiocarbonyl functional group is thioacetamide (TA). In another embodiment, the reagent having the thiocarbonyl functional group is sodium-dimethyldithiocarbamate (SDDC). In another embodiment, the reagent having the thiocarbonyl functional group is ethylene trithiocarbonate (ETC). In another embodiment, the reagent having the thiocarbonyl functional group is thiosemicarbazide (TSCA).

In an embodiment, the reagent having the thiocarbonyl functional group is present in the acidic conditions at a concentration of about 50 mM or lower. In another embodiment, the reagent having the thiocarbonyl functional group is present in the acidic conditions at a concentration of about 0.002 mM to about 50 mM. In another embodiment, the reagent having the thiocarbonyl functional group is present in the acidic conditions at a concentration of about 0.002 mM to about 30 mM. In another embodiment, the reagent having the thiocarbonyl functional group is present in the acidic conditions at a concentration of about 0.002 mM to about 20 mM. In another embodiment, the reagent having the thiocarbonyl functional group is present in the acidic conditions at a concentration of about 0.002 mM to about 10 mM. In another embodiment, the reagent having the thiocarbonyl functional group is present in the acidic conditions at a concentration of about 0.002 mM to about 5 mM. In another embodiment, the reagent having the thiocarbonyl functional group is present in the acidic conditions at a concentration of about 0.002 mM to about 2 mM. In another embodiment, the reagent having the thiocarbonyl functional group is present in the acidic conditions at a concentration of about 0.002 mM to about 1 mM. In another embodiment, the reagent having the thiocarbonyl functional group is present in the acidic conditions at a concentration of about 0.002 mM to about 0.2 mM. In another embodiment, the reagent having the thiocarbonyl functional group is present in the acidic conditions at a concentration of about 0.002 mM to about 0.02 mM. In another embodiment, the reagent having the thiocarbonyl functional group is present in the acidic conditions at a concentration of about 0.02 mM to about 50 mM. In another embodiment, the reagent having the thiocarbonyl functional group is present in the acidic conditions at a concentration of about 0.02 mM to about 30 mM. In another embodiment, the reagent having the thiocarbonyl functional group is present in the acidic conditions at a concentration of about 0.02 mM to about 20 mM. In another embodiment, the reagent having the thiocarbonyl functional group is present in the acidic conditions at a concentration of about 0.02 mM to about 10 mM. In another embodiment, the reagent having the thiocarbonyl functional group is present in the acidic conditions at a concentration of about 0.02 mM to about 5 mM. In another embodiment, the reagent having the thiocarbonyl functional group is present in the acidic conditions at a concentration of about 0.02 mM to about 2 mM. In another embodiment, the reagent having the thiocarbonyl functional group is present in the acidic conditions at a concentration of about 0.02 mM to about 1 mM. In another embodiment, the reagent having the thiocarbonyl functional group is present in the acidic conditions at a concentration of about 0.02 mM to about 0.2 mM. In another embodiment, the reagent having the thiocarbonyl functional group is present in the acidic conditions at a concentration of about 0.2 mM to about 50 mM. In another embodiment, the reagent having the thiocarbonyl functional group is present in the acidic conditions at a concentration of about 0.2 mM to about 30 mM. In another embodiment, the reagent having the thiocarbonyl functional group is present in the acidic conditions at a concentration of about 0.2 mM to about 20 mM. In another embodiment, the reagent having the thiocarbonyl functional group is present in the acidic conditions at a concentration of about 0.2 mM to about 10 mM. In another embodiment, the reagent having the thiocarbonyl functional group is present in the acidic conditions at a concentration of about 0.2 mM to about 5 mM. In another embodiment, the reagent having the thiocarbonyl functional group is present in the acidic conditions at a concentration of about 0.2 mM to about 2 mM. In another embodiment, the reagent having the thiocarbonyl functional group is present in the acidic conditions at a concentration of about 0.2 mM to about 1 mM.

The present disclosure also includes a use of formamidine disulfide (FDS) for liberating a precious metal from a material, wherein the material comprises a sulfide encapsulating the precious metal; and wherein the material is contacted under acidic conditions with the FDS. In an embodiment, the material is contacted with the FDS by a method comprising: contacting the material with an acidic mixture comprising the FDS.

In an embodiment, the FDS is present in the acidic conditions at a concentration of about 25 mM or lower. In another embodiment, the FDS is present in the acidic conditions at a concentration of about 0.001 mM to about 25 mM. In another embodiment, the FDS is present in the acidic conditions at a concentration of about 0.001 mM to about 15 mM. In another embodiment, the FDS is present in the acidic conditions at a concentration of about 0.001 mM to about 10 mM. In another embodiment, the FDS is present in the acidic conditions at a concentration of about 0.001 mM to about 5 mM. In another embodiment, the FDS is present in the acidic conditions at a concentration of about 0.001 mM to about 2.5 mM. In another embodiment, the FDS is present in the acidic conditions at a concentration of about 0.001 mM to about 1 mM. In another embodiment, the FDS is present in the acidic conditions at a concentration of about 0.001 mM to about 0.5 mM. In another embodiment, the FDS is present in the acidic conditions at a concentration of about 0.001 mM to about 0.1 mM. In another embodiment, the FDS is present in the acidic conditions at a concentration of about 0.001 mM to about 0.01 mM. In another embodiment, the FDS is present in the acidic conditions at a concentration of about 0.01 mM to about 25 mM. In another embodiment, the FDS is present in the acidic conditions at a concentration of about 0.01 mM to about 15 mM. In another embodiment, the FDS is present in the acidic conditions at a concentration of about 0.01 mM to about 10 mM. In another embodiment, the FDS is present in the acidic conditions at a concentration of about 0.01 mM to about 5 mM. In another embodiment, the FDS is present in the acidic conditions at a concentration of about 0.01 mM to about 2.5 mM. In another embodiment, the FDS is present in the acidic conditions at a concentration of about 0.01 mM to about 1 mM. In another embodiment, the FDS is present in the acidic conditions at a concentration of about 0.01 mM to about 0.5 mM. In another embodiment, the FDS is present in the acidic conditions at a concentration of about 0.01 mM to about 0.1 mM. In another embodiment, the FDS is present in the acidic conditions at a concentration of about 0.1 mM to about 25 mM. In another embodiment, the FDS is present in the acidic conditions at a concentration of about 0.1 mM to about 15 mM. In another embodiment, the FDS is present in the acidic conditions at a concentration of about 0.1 mM to about 10 mM. In another embodiment, the FDS is present in the acidic conditions at a concentration of about 0.1 mM to about 5 mM. In another embodiment, the FDS is present in the acidic conditions at a concentration of about 0.1 mM to about 2.5 mM. In another embodiment, the FDS is present in the acidic conditions at a concentration of about 0.1 mM to about 1 mM. In another embodiment, the FDS is present in the acidic conditions at a concentration of about 0.1 mM to about 0.5 mM.

In an embodiment, the material is agglomerated prior to contact.

In an embodiment, the acidic conditions further comprise an oxidizing agent. In another embodiment, the oxidizing agent comprises ferric sulfate.

In an embodiment, the contact further comprises bio-oxidation of the material. In another embodiment, the material further comprises sulfur-oxidizing bacteria, iron-oxidizing bacteria, bacteria that are sulfur-oxidizing and iron-oxidizing or combinations thereof. In another embodiment, the acidic mixture further comprises sulfur-oxidizing bacteria, iron-oxidizing bacteria or bacteria that are sulfur-oxidizing and iron-oxidizing, or combinations thereof. In another embodiment, the bacteria are sulfur-oxidizing. In another embodiment, the bacteria are iron-oxidizing. In another embodiment, the bacteria are sulfur-oxidizing and iron-oxidizing.

In an embodiment, the sulfide comprises a sulfide mineral. In another embodiment, the sulfide comprises sulfur, iron, arsenic, antimony or combinations thereof. In another embodiment, the sulfide comprises sulfur. In another embodiment, the sulfide comprises iron. In another embodiment, the sulfide comprises arsenic. In another embodiment, the sulfide comprises antimony. In another embodiment, the sulfide comprises pyrite, marcasite, arsenian pyrite, arsenopyrite, pyrrhotite, enargite, bornite, chalcopyrite or combinations thereof. In another embodiment, the sulfide comprises pyrite. In another embodiment, the sulfide comprises arsenian pyrite. In another embodiment, the sulfide comprises marcasite. In another embodiment, the sulfide comprises arsenopyrite. In another embodiment, the sulfide comprises pyrrhotite. In another embodiment, the sulfide comprises enargite. In another embodiment, the sulfide comprises bornite. In another embodiment, the sulfide comprises chalcopyrite. In another embodiment, the sulfide comprises pyrite, arsenian pyrite, arsenopyrite or combinations thereof.

In an embodiment, the precious metal comprises a platinum group metal, gold, silver or combinations thereof. In another embodiment, the precious metal comprises gold. In another embodiment, the precious metal comprises silver. In another embodiment, the precious metal comprises a platinum group metal. In another embodiment, the precious metal comprises platinum. In another embodiment, the precious metal comprises gold, silver or combinations thereof.

In an embodiment, the material further comprises a base metal.

In an embodiment, an acid is added to obtain the acidic conditions. In another embodiment, the acid comprises sulfuric acid.

In an embodiment, pH of the acidic conditions is in a range of from about 0 to about 6.5. In another embodiment, the pH of the acidic conditions is about 2.

In an embodiment, the contacting comprises a method comprising a percolation, a tank, a vat or combinations thereof. In another embodiment, the contacting comprises a method comprising a percolation. In another embodiment, the method comprising a percolation is a method comprising a heap or a dump. In another embodiment, the percolation comprises a heap. In another embodiment, the percolation comprises a dump. In another embodiment, the contacting comprises a method comprising a tank. In another embodiment, the contacting comprises a method comprising a vat.

In an embodiment, the contacting produces a residue comprising the precious metal. In an embodiment, subsequent to contact, the method further comprises pressure oxidation to produce a residue comprising the precious metal.

The present disclosure also includes a use of a reagent having a thiocarbonyl functional group or formamidine disulfide (FDS), as the case may be, in a method for extracting a precious metal from a material comprising a sulfide encapsulating the precious metal, the method comprising a method as described herein for liberating a precious metal from a material, wherein the material comprises a sulfide encapsulating the precious metal, the method comprising contacting the material under acidic conditions with a reagent having a thiocarbonyl functional group wherein the contacting produces a residue comprising the precious metal; and leaching the precious metal from the residue comprising the precious metal.

In an embodiment, the leaching comprises contacting the residue with a lixiviant to extract the precious metal from the residue. In another embodiment, the lixiviant comprises cyanide, thiosulfate, glycine, thiocyanate, chloride, a reagent having a thiocarbonyl functional group or iodine/iodide. In another embodiment, the leaching comprises cyanidation. In another embodiment, the lixiviant comprises a reagent having a thiocarbonyl functional group.

In an embodiment, prior to leaching, the use further comprises washing the residue comprising the precious metal.

In an embodiment, the leaching comprises a percolation leach, a tank leach, a vat leach or combinations thereof. In another embodiment, the percolation leach is a heap leach or a dump leach. In another embodiment, the leaching comprises a tank leach.

In an embodiment, the use further comprises recovering the precious metal. In an embodiment, the leaching produces a pregnant leach solution comprising the precious metal and the use further comprises recovering the precious metal from the pregnant leach solution. In another embodiment, the recovering comprises cementation, ion exchange, adsorption of the precious metal on carbon, reduction of the precious metal with a reducing agent, solvent extraction or recovering, electrowinning or combinations thereof. In another embodiment, prior to the recovering, the use further comprises a solid-liquid separation.

In an embodiment, the use further comprises recovering the reagent having the thiocarbonyl functional group or the FDS. In another embodiment, use further comprises recycling the recovered reagent having the thiocarbonyl functional group or FDS for use in the contacting of a further portion of the material and/or a further portion of the residue.

In an embodiment, the contact is at ambient temperature and pressure. In another embodiment, the contact is at ambient temperature. In another embodiment, the contact is at ambient pressure.

In an embodiment, the use is a batch use.

In an embodiment, the use is a continuous use.

Aspects of the disclosure relate to a method for liberating a precious metal from a material, the method comprising: contacting the material under acidic conditions with a reagent comprising a thiocarbonyl functional group, wherein the material comprises a sulfide encapsulating the precious metal. In various embodiments, contacting the material under acidic conditions comprises contacting the material with an acidic mixture.

In various embodiments, the reagent comprising the thiocarbonyl functional group comprises a monomer of the reagent. In various embodiments, the reagent comprising the thiocarbonyl functional group is added in the form of the corresponding dimer.

In various embodiments, reagent comprising the thiocarbonyl functional group is not thiourea. In various embodiments, the reagent comprising the thiocarbonyl functional group comprises N—N′ substituted thioureas; 2,5-dithiobiurea; dithiobiuret; thiosemicarbazide purum; thiosemicarbazide; thioacetamide; 2-methyl-3-thiosemicarbazide; 4-methyl-3-thiosemicarbazide; vinylene trithiocarbonate purum; vinylene trithiocarbonate; 2-cyanothioacetamide; ethylene trithiocarbonate; potassium ethyl xanthogenate; dimethylthiocarbamoyl chloride; dimethyldithiocarbamate; dimethyl trithiocarbonate; N,N-dimethylthioformamide; 4,4-dimethyl-3-thiosemicarbazide; 4-ethyl-3-thiosemicarbazide; O-isopropylxanthic acid; ethyl thiooxamate; ethyl dithioacetate; pyrazine-2-thiocarboxamide; diethylthiocarbamoyl chloride; diethyldithiocarbamate; tetramethylthiuram monosulfide; tetramethylthiuram disulfide; pentafluorophenyl chlorothionoformate; 4-fluorophenyl chlorothionoformate; O-phenyl chlorothionoformate; phenyl chlorodithioformate; 3,4-difluorothiobenzamide; 2-bromothiobenzamide; 3-bromothiobenzamide; 4-bromothiobenzamide; 4-chlorothiobenzamide; 4-fluorothiobenzamide; thiobenzoic acid; thiobenzamide; 4-phenylthiosemicarbazide; O-(p-tolyl) chlorothionoformate; 4-bromo-2-methylthiobenzamide; 3-methoxythiobenzamide; 4-methoxythiobenzamide; 4-methylbenzenethioamide; thioacetanilide; salicylaldehyde thiosemicarbazone; indole-3-thiocarboxamide; S-(thiobenzoyl)thioglycolic acid; 3-(acetoxy)thiobenzamide; 4-(acetoxy)thiobenzamide; methyl N′-[(e)-(4-chlorophenyl)methylidene]hydrazonothiocarbamate; 3-ethoxythiobenzamide; 4-ethylbenzene-1-thiocarboxamide; tert-butyl 3-[(methylsulfonyl)oxy]-1-azetanecarboxylate; diethyldithiocarbamic acid; 2-(phenylcarbonothioylthio)propanoic acid; 2-hydroxybenzaldehyde N-ethylthiosemicarbazone; (1R,4R)-1,7,7-trimethylbicyclo[2.2.1]heptane-2-thione; tetraethylthiuram disulfide; 4′-hydroxybiphenyl-4-thiocarboxamide; 4-biphenylthioamide; dithizone; 4′-methylbiphenyl-4-thiocarboxamide; tetraisopropylthiuram disulfide; anthracene-9-thiocarboxamide; phenanthrene-9-thiocarboxamide; sodium dibenzyldithiocarbamate; 4,4′-bis(dimethylamino)thiobenzophenone; or any combination thereof.

In various embodiments, the reagent comprising the thiocarbonyl functional group comprises thiourea. In various embodiments, the reagent comprising the thiocarbonyl functional group is thiourea (Tu).

In various embodiments, the reagent comprising the thiocarbonyl functional group comprises thiourea (Tu), thioacetamide (TA), sodium-dimethyldithiocarbamate (SDDC), ethylene trithiocarbonate (ETC), thiosemicarbazide (TSCA), or any combination thereof

In various embodiments, the reagent comprising the thiocarbonyl functional group comprises thioacetamide (TA). In various embodiments, the reagent comprising the thiocarbonyl functional group comprises sodium-dimethyldithiocarbamate (SDDC). In various embodiments, the reagent comprising the thiocarbonyl functional group comprises ethylene trithiocarbonate (ETC). In various embodiments, the reagent comprising the thiocarbonyl functional group comprises thiosemicarbazide (TSCA).

In various embodiments, the reagent comprising the thiocarbonyl functional group is at a concentration of about 50 mM or lower. In various embodiments, the reagent comprising the thiocarbonyl functional group is at a concentration of about 0.002 mM to about 50 mM, about 0.002 mM to about 30 mM, about 0.002 mM to about 20 mM, about 0.002 mM to about 10 mM, about 0.002 mM to about 5 mM, about 0.002 mM to about 2 mM, about 0.002 mM to about 1 mM, about 0.002 mM to about 0.2 mM, about 0.002 mM to about 0.02 mM, about 0.02 mM to about 50 mM, about 0.02 mM to about 30 mM, about 0.02 mM to about 20 mM, about 0.02 mM to about 10 mM, about 0.02 mM to about 5 mM, about 0.02 mM to about 2 mM, about 0.02 mM to about 1 mM, about 0.02 mM to about 0.2 mM, about 0.2 mM to about 50 mM, about 0.2 mM to about 30 mM, about 0.2 mM to about 20 mM, about 0.2 mM to about 10 mM, about 0.2 mM to about 5 mM, about 0.2 mM to about 2 mM, about 0.2 mM to about 1 mM, about 2 mM to about 50 mM, about 2 mM to about 30 mM, about 2 mM to about 20 mM, about 2 mM to about 10 mM, about 2 mM to about 4 mM, about 10 mM to about 50 mM, about 10 mM to about 30 mM, about 10 mM to about 20 mM, or about 30 mM to about 50 mM.

Aspects of the disclosure relate to a method for liberating a precious metal from a material, the method comprising: contacting the material under acidic conditions with formamidine disulfide (FDS), wherein the material comprises a sulfide encapsulating the precious metal. In various embodiments, contacting the material under acidic conditions comprises contacting the material with an acidic mixture.

In various embodiments, the FDS is at a concentration of about 25 mM or lower. In various embodiments, the FDS is at a concentration of about 0.001 mM to about 25 mM, about 0.001 mM to about 15 mM, about 0.001 mM to about 10 mM, about 0.001 mM to about 5 mM, about 0.001 mM to about 2.5 mM, about 0.001 mM to about 1 mM, about 0.001 mM to about 0.5 mM, about 0.001 mM to about 0.1 mM, about 0.001 mM to about 0.01 mM, about 0.01 mM to about 25 mM, about 0.01 mM to about 15 mM, about 0.01 mM to about 10 mM, about 0.01 mM to about 5 mM, of about 0.01 mM to about 2.5 mM, about 0.01 mM to about 1 mM, about 0.01 mM to about 0.5 mM, about 0.01 mM to about 0.1 mM, about 0.1 mM to about 25 mM, about 0.1 mM to about 15 mM, about 0.1 mM to about 10 mM, about 0.1 mM to about 5 mM, about 0.1 mM to about 2.5 mM, about 0.1 mM to about 1 mM, about 0.1 mM to about 0.5 mM, about 1 mM to about 25 mM, about 1 mM to about 15 mM, about 1 mM to about 10 mM, or about 1 mM to about 5 mM, about 1 mM to about 2 mM, about 5 mM to about 25 mM, about 5 mM to about 15 mM, about 5 mM to about 10 mM, or about 15 mM to about 25 mM.

In various embodiments these methods, the material is agglomerated. In various embodiments, the acidic conditions further comprise an oxidizing agent. In various embodiments, the oxidizing agent comprises oxygen. In various embodiments, the oxidizing agent comprises a source of Fe³⁺ (ferric) ions. In various embodiments, the source of ferric ions comprises a direct source of ferric ions. In various embodiments, the source of ferric ions comprises an indirect source of ferric ions. In various embodiments, the indirect source of ferric ions comprises Fe²⁺ ions converted to Fe³⁺ ions. In various embodiments, the Fe²⁺ ions are converted to Fe³⁺ ions by an electrochemical method. In various embodiments, the indirect source of ferric ions comprises iron(II) sulfate. In various embodiments, the source of ferric ions comprises an iron (III) salt. In various embodiments, the oxidizing agent comprises ferric sulfate. In various embodiments, the ferric sulfate is at a concentration of less than 10 g/L of Fe³⁺. In various embodiments, the ferric sulfate is at a concentration of about 0.5 g/L of Fe³⁺ to about 20 g/L of Fe³⁺. In various embodiments, the ferric sulfate is at a concentration of about 1.5 g/L of Fe³⁺ to about 3 g/L of Fe³⁺. In various embodiments, the ferric sulfate is at a concentration of about 2 g/L of Fe³⁺ to about 2.5 g/L of Fe³⁺.

In various embodiments, the method further comprises bio-oxidation of the material. In various embodiments, the material further comprises sulfur-oxidizing bacteria, iron-oxidizing bacteria, bacteria that are sulfur-oxidizing and iron-oxidizing or a combination thereof. In various embodiments, the acidic mixture further comprises sulfur-oxidizing bacteria, iron-oxidizing bacteria, bacteria that are sulfur-oxidizing and iron-oxidizing or a combination thereof. In various embodiments, the bacteria comprises sulfur-oxidizing bacteria. In various embodiments, the bacteria comprises iron-oxidizing bacteria. In various embodiments, the bacteria comprises sulfur-oxidizing bacteria, iron-oxidizing bacteria, or a combination thereof. In various embodiments, the bacteria comprises Acidothiobacilos ferrooxidans.

In various embodiments, the sulfide comprises a sulfide mineral. In various embodiments, the sulfide comprises sulfur, iron, arsenic, antimony or combinations thereof. In various embodiments, the sulfide comprises sulfur. In various embodiments, the sulfide comprises iron.

In various embodiments, the sulfide comprises a metal sulfide. In various embodiments, the metal sulfide comprises a base metal sulfide. In various embodiments, the base metal sulfide comprises a copper sulfide, a nickel sulfide, or a cadmium sulfide.

In various embodiments, the sulfide comprises arsenic. In various embodiments, the sulfide comprises antimony. In various embodiments, the sulfide comprises pyrite, arsenian pyrite, marcasite, arsenopyrite, pyrrhotite, enargite, bornite, chalcopyrite, or a combination thereof. In various embodiments, the sulfide comprises pyrite. In various embodiments, the sulfide comprises arsenian pyrite. In various embodiments, the sulfide comprises marcasite. In various embodiments, the sulfide comprises arsenopyrite. In various embodiments, the sulfide comprises pyrrhotite. In various embodiments, the sulfide comprises enargite. In various embodiments, the sulfide comprises bornite. In various embodiments, the sulfide comprises chalcopyrite. In various embodiments, the sulfide comprises pyrite, arsenian pyrite, arsenopyrite, or a combination thereof.

In various embodiments, the precious metal comprises a platinum group metal, gold, silver, or a combination thereof. In various embodiments, the precious metal comprises gold. In various embodiments, the precious metal comprises silver. In various embodiments, the precious metal comprises a platinum group metal. In various embodiments, the precious metal comprises platinum. In various embodiments, the precious metal comprises gold, silver, or a combination thereof.

In various embodiments, the material further comprises a base metal.

In various embodiments, the method comprises adding an acid to obtain the acidic conditions. In various embodiments, the acid comprises sulfuric acid.

In various embodiments, the pH of the acidic conditions is in a range of about 0 to about 6.5. In various embodiments, the pH of the acidic conditions is in a range of about 0.5 to about 4. In various embodiments, the pH of the acidic conditions is in a range of about 1 to about 3. In various embodiments, the pH of the acidic conditions is in a range of about 1.5 to about 2.5. In various embodiments, the pH of the acidic conditions is in a range of about 2 to about 2.5.

In various embodiments, the contacting comprises a method comprising a percolation, a tank, a vat or combinations thereof. In various embodiments, the percolation comprises a heap, a dump, or a combination thereof.

In various embodiments, the contacting comprises a percolation leach, a tank leach, a vat leach, or combinations thereof. In various embodiments, the percolation leach comprises a heap leach, a dump leach, or a combination thereof.

In various embodiments, contacting produces a residue comprising the precious metal. In various embodiments, the method comprises pressure oxidation to produce a residue comprising the precious metal.

Aspects of the disclosure relate to a method for extracting a precious metal from a material comprising a sulfide encapsulating the precious metal, the method comprising: liberating a precious metal from a material according to a method as described above to produce a residue comprising the precious metal; and leaching the precious metal from the residue comprising the precious metal.

In various embodiments, the leaching comprises contacting the residue with a lixiviant. In various embodiments, the lixiviant comprises cyanide, thiosulfate, glycine, thiocyanate, chloride, a reagent comprising a thiocarbonyl functional group, iodine/iodide, or a combination thereof. In various embodiments, the leaching comprises cyanidation. In various embodiments, the lixiviant comprises a reagent comprising a thiocarbonyl functional group.

In various embodiments, the method further comprises washing the residue comprising the precious metal.

In various embodiments, the leaching is carried out in a method comprising a percolation leach, a tank leach, a vat leach, or a combination thereof. In various embodiments, the percolation leach is a heap leach, a dump leach, or a combination thereof. In various embodiments, the leaching is carried out in a method comprising a tank leach.

In various embodiments, the method further comprises recovering the precious metal. In various embodiments, the leaching produces a pregnant leach solution comprising the precious metal and the method further comprises recovering the precious metal from the pregnant leach solution. In various embodiments, the recovering comprises cementation, ion exchange, adsorption of the precious metal on carbon, reduction of the precious metal with a reducing agent, solvent extraction or recovering, electrowinning or combinations thereof. In various embodiments, the recovering comprises cementation. In various embodiments, the recovering comprises ion exchange. In various embodiments, the recovering comprises adsorption of the precious metal on carbon. In various embodiments, the recovering comprises reduction of the precious metal with a reducing agent. In various embodiments, the recovering comprises solvent extraction or recovering. In various embodiments, the recovering comprises electrowinning.

In various embodiments, the method comprises a solid-liquid separation.

In various embodiments, the method further comprises recovering the reagent comprising the thiocarbonyl functional group or the FDS. In various embodiments, the method further comprises recycling the recovered reagent comprising the thiocarbonyl functional group or FDS for use in the contacting of a further portion of the material and/or a further portion of the residue.

In various embodiments of the methods described above, the contacting is at ambient temperature and pressure. In various embodiments, the contacting is at ambient temperature. In various embodiments, the contacting is at a temperature of between about 0° C. to about 80° C., between about 5° C. to about 55° C., between about 15° C. to about 25° C.

In various embodiments, the contacting is at ambient pressure. In various embodiments, ambient pressure is about 1 atm.

In various embodiments of the methods described above, the method comprises a batch method. In various embodiments of the methods described above, the method comprises a continuous method.

Aspects of the disclosure relate to use of a reagent comprising a thiocarbonyl functional group for liberating a precious metal from a material, wherein the material comprises a sulfide encapsulating the precious metal. In various embodiments, the use is under acidic conditions. In various embodiments, the acidic conditions are provided by contact of the material with an acidic mixture. In various embodiments, the reagent comprising the thiocarbonyl functional group comprises a monomer.

In various embodiments, the reagent comprising the thiocarbonyl functional group is not thiourea. In various embodiments, the reagent comprising the thiocarbonyl functional group comprises N—N′ substituted thioureas; 2,5-dithiobiurea; dithiobiuret; thiosemicarbazide purum; thiosemicarbazide; thioacetamide; 2-methyl-3-thiosemicarbazide; 4-methyl-3-thiosemicarbazide; vinylene trithiocarbonate purum; vinylene trithiocarbonate; 2-cyanothioacetamide; ethylene trithiocarbonate; potassium ethyl xanthogenate; dimethylthiocarbamoyl chloride; dimethyldithiocarbamate; dimethyl trithiocarbonate; N,N-dimethylthioformamide; 4,4-dimethyl-3-thiosemicarbazide; 4-ethyl-3-thiosemicarbazide; O-isopropylxanthic acid; ethyl thiooxamate; ethyl dithioacetate; pyrazine-2-thiocarboxamide; diethylthiocarbamoyl chloride; diethyldithiocarbamate; tetramethylthiuram monosulfide; tetramethylthiuram disulfide; pentafluorophenyl chlorothionoformate; 4-fluorophenyl chlorothionoformate; O-phenyl chlorothionoformate; phenyl chlorodithioformate; 3,4-difluorothiobenzamide; 2-bromothiobenzamide; 3-bromothiobenzamide; 4-bromothiobenzamide; 4-chlorothiobenzamide; 4-fluorothiobenzamide; thiobenzoic acid; thiobenzamide; 4-phenylthiosemicarbazide; O-(p-tolyl) chlorothionoformate; 4-bromo-2-methylthiobenzamide; 3-methoxythiobenzamide; 4-methoxythiobenzamide; 4-methylbenzenethioamide; thioacetanilide; salicylaldehyde thiosemicarbazone; indole-3-thiocarboxamide; S-(thiobenzoyl)thioglycolic acid; 3-(acetoxy)thiobenzamide; 4-(acetoxy)thiobenzamide; methyl N′-[(e)-(4-chlorophenyl)methylidene]hydrazonothiocarbamate; 3-ethoxythiobenzamide; 4-ethylbenzene-1-thiocarboxamide; tert-butyl 3-[(methylsulfonyl)oxy]-1-azetanecarboxylate; diethyldithiocarbamic acid; 2-(phenylcarbonothioylthio)propanoic acid; 2-hydroxybenzaldehyde N-ethylthiosemicarbazone; (1R,4R)-1,7,7-trimethylbicyclo[2.2.1]heptane-2-thione; tetraethylthiuram disulfide; 4′-hydroxybiphenyl-4-thiocarboxamide; 4-biphenylthioamide; dithizone; 4′-methylbiphenyl-4-thiocarboxamide; tetraisopropylthiuram disulfide; anthracene-9-thiocarboxamide; phenanthrene-9-thiocarboxamide; sodium dibenzyldithiocarbamate; 4,4′-bis(dimethylamino)thiobenzophenone; or any combination thereof.

In various embodiments, the reagent comprising the thiocarbonyl functional group comprises thiourea, ethylene thiourea, thioacetamide, sodium dimethyldithiocarbamate, ethylene trithiocarbonate, thiosemicarbazide or an combination thereof.

In various embodiments, the reagent comprising the thiocarbonyl functional group comprises thiourea. In various embodiments, the reagent comprising the thiocarbonyl functional group is thiourea (Tu). In various embodiments, the reagent comprising the thiocarbonyl functional group is for provision in the form of the corresponding dimer.

In various embodiments, the reagent comprising the thiocarbonyl functional group comprises thioacetamide (TA). In various embodiments, the reagent comprising the thiocarbonyl functional group comprises sodium-dimethyldithiocarbamate (SDDC). In various embodiments, the reagent comprising the thiocarbonyl functional group comprises ethylene trithiocarbonate (ETC). In various embodiments, the reagent comprising the thiocarbonyl functional group comprises thiosemicarbazide (TSCA).

In various embodiments, the reagent comprising the thiocarbonyl functional group is at a concentration of about 50 mM or lower. In various embodiments, the reagent comprising the thiocarbonyl functional group is at a concentration of about 0.002 mM to about 50 mM, about 0.002 mM to about 30 mM, about 0.002 mM to about 20 mM, about 0.002 mM to about 10 mM, about 0.002 mM to about 5 mM, about 0.002 mM to about 2 mM, about 0.002 mM to about 1 mM, about 0.002 mM to about 0.2 mM, about 0.002 mM to about 0.02 mM, about 0.02 mM to about 50 mM, about 0.02 mM to about 30 mM, about 0.02 mM to about 20 mM, about 0.02 mM to about 10 mM, about 0.02 mM to about 5 mM, about 0.02 mM to about 2 mM, about 0.02 mM to about 1 mM, about 0.02 mM to about 0.2 mM about 0.2 mM to about 50 mM, about 0.2 mM to about 30 mM, about 0.2 mM to about 20 mM, about 0.2 mM to about 10 mM, about 0.2 mM to about 5 mM, about 0.2 mM to about 2 mM, about 0.2 mM to about 1 mM, about 2 mM to about 50 mM, about 2 mM to about 30 mM, about 2 mM to about 20 mM, about 2 mM to about 10 mM, about 2 mM to about 4 mM, about 10 mM to about 50 mM, about 10 mM to about 30 mM, about 10 mM to about 20 mM, or about 30 mM to about 50 mM.

Aspects of the disclosure relate to use of formamidine disulfide (FDS) for liberating a precious metal from a material, wherein the material comprises a sulfide encapsulating the precious metal. In various embodiments, the use is under acidic conditions. In various embodiments, the acidic conditions are provided by contact of the material with an acidic mixture.

Aspects of the disclosure relate to use of formamidine disulfide (FDS) for liberating a precious metal from a material, wherein the material comprises a sulfide encapsulating the precious metal; and wherein the material is contacted under acidic conditions with the FDS. In various embodiments, the acidic conditions are provided by contact of the material with an acidic mixture.

In various embodiments, the FDS is at a concentration of about 25 mM or lower. In various embodiments, the FDS is at a concentration of about 0.001 mM to about 25 mM, about 0.001 mM to about 15 mM, about 0.001 mM to about 10 mM, about 0.001 mM to about 5 mM, about 0.001 mM to about 2.5 mM, about 0.001 mM to about 1 mM, about 0.001 mM to about 0.5 mM, about 0.001 mM to about 0.1 mM, about 0.001 mM to about 0.01 mM, about 0.01 mM to about 25 mM, about 0.01 mM to about 15 mM, about 0.01 mM to about 10 mM, about 0.01 mM to about 5 mM, about 0.01 mM to about 2.5 mM, about 0.01 mM to about 1 mM, about 0.01 mM to about 0.5 mM, about 0.01 mM to about 0.1 mM, about 0.1 mM to about 25 mM, about 0.1 mM to about 15 mM, about 0.1 mM to about 10 mM, about 0.1 mM to about 5 mM, about 0.1 mM to about 2.5 mM, about 0.1 mM to about 1 mM, about 0.1 mM to about 0.5 mM, about 1 mM to about 25 mM, about 1 mM to about 15 mM, about 1 mM to about 10 mM, about 1 mM to about 5 mM, about 1 mM to about 2 mM, about 5 mM to about 25 mM, about 5 mM to about 15 mM, about 5 mM to about 10 mM, or about 15 mM to about 25 mM.

In various embodiments of the uses described above, the material is agglomerated.

In various embodiments, the acidic conditions further comprise an oxidizing agent. In various embodiments, the oxidizing agent comprises oxygen. In various embodiments, the oxidizing agent comprises a source of Fe³⁺ (ferric) ions. In various embodiments, the source of ferric ions comprises a direct source of ferric ions. In various embodiments, the source of ferric ions comprises an indirect source of ferric ions. In various embodiments, the indirect source of ferric ions comprises Fe²⁺ ions converted to Fe³⁺ ions. In various embodiments, the Fe²⁺ ions are converted to Fe³⁺ ions by an electrochemical method. The In various embodiments, the indirect source of ferric ions comprises iron(II) sulfate. In various embodiments, the source of ferric ions comprises an iron (III) salt. In various embodiments, the oxidizing agent comprises ferric sulfate. In various embodiments, the ferric sulfate is at a concentration of less than 10 g/L of Fe³⁺. In various embodiments, the ferric sulfate is at a concentration of about 0.5 g/L of Fe³⁺ to about 20 g/L of Fe³⁺. In various embodiments, the ferric sulfate is at a concentration of about 1.5 g/L of Fe³⁺ to about 3 g/L of Fe³⁺. In various embodiments, the ferric sulfate is at a concentration of about 2 g/L of Fe³⁺ to about 2.5 g/L of Fe³⁺.

In various embodiments, the contacting is further for bio-oxidation of the material. In various embodiments, the material further comprises sulfur-oxidizing bacteria, iron-oxidizing bacteria, bacteria that are sulfur-oxidizing and iron-oxidizing or combinations thereof. In various embodiments, the acidic mixture comprises sulfur-oxidizing bacteria, iron-oxidizing bacteria or bacteria that are sulfur-oxidizing and iron-oxidizing, or combinations thereof. In various embodiments, the bacteria comprise sulfur-oxidizing bacteria. The In various embodiments, the bacteria comprise iron-oxidizing bacteria. In various embodiments, the bacteria comprise sulfur-oxidizing bacteria, iron-oxidizing bacteria, or a combination thereof. In various embodiments, the bacteria comprise Acidothiobacilos ferrooxidans.

In various embodiments, the sulfide comprises a sulfide mineral. In various embodiments, the sulfide comprises sulfur, iron, arsenic, antimony, or a combination thereof. In various embodiments, the sulfide comprises sulfur. In various embodiments, the sulfide comprises iron.

In various embodiments, the sulfide comprises a metal sulfide. In various embodiments, the metal sulfide comprises a base metal sulfide. In various embodiments, the base metal sulfide comprises a copper sulfide, a nickel sulfide, or a cadmium sulfide.

In various embodiments, the sulfide comprises arsenic. In various embodiments, the sulfide comprises antimony. In various embodiments, the sulfide comprises pyrite, marcasite, arsenian pyrite, arsenopyrite, pyrrhotite, enargite, bornite, chalcopyrite, or a combination thereof. In various embodiments, wherein the sulfide comprises pyrite. In various embodiments, the sulfide comprises arsenian pyrite. In various embodiments, the sulfide comprises marcasite. In various embodiments, the sulfide comprises arsenopyrite. In various embodiments, the sulfide comprises pyrrhotite. In various embodiments, the sulfide comprises enargite. In various embodiments, the sulfide comprises bornite. In various embodiments, the sulfide comprises chalcopyrite. In various embodiments, the sulfide comprises pyrite, arsenian pyrite, arsenopyrite, or a combination thereof.

In various embodiments, the precious metal comprises a platinum group metal, gold, silver or combinations thereof.

In various embodiments, the precious metal comprises gold. In various embodiments, the precious metal comprises silver. In various embodiments, the precious metal comprises a platinum group metal. In various embodiments, the precious metal comprises platinum. In various embodiments, the precious metal comprises gold, silver, or a combination thereof.

In various embodiments, the material further comprises a base metal.

In various embodiments, an acid is added to obtain the acidic conditions. In various embodiments, the acid comprises sulfuric acid.

In various embodiments, the pH of the acidic conditions is in a range of from about 0 to about 6.5. In various embodiments, the pH of the acidic conditions is in a range of about 0.5 to about 4. The use of claim Error! Reference source not found., wherein the pH of the acidic conditions is in a range of about 1 to about 3. In various embodiments, the pH of the acidic conditions is in a range of about 1.5 to about 2.5. n various embodiments, the pH of the acidic conditions is in a range of about 2 to about 2.5.

In various embodiments, the contacting comprises a method comprising a percolation, a tank, a vat, or a combination thereof. In various embodiments, the contacting comprises a method comprising a percolation. In various embodiments, the method comprising a percolation is a method comprising a heap, a dump, or a combination thereof.

In various embodiments, the percolation comprises a heap. The In various embodiments, the percolation comprises a dump. In various embodiments, the contacting comprises a method comprising a tank. In various embodiments, the contacting comprises a method comprising a vat.

In various embodiments, the contacting comprises a percolation leach, a tank leach, a vat leach, or combinations thereof. In various embodiments, the percolation leach comprises a heap leach, a dump leach, or a combination thereof.

In various embodiments, the contacting produces a residue comprising the precious metal. In various embodiments, subsequent to contact, pressure oxidation is used to produce a residue comprising the precious metal.

Aspects of the disclosure relate to use of a reagent comprising a thiocarbonyl functional group or formamidine disulfide (FDS) in a method for extracting a precious metal from a material comprising a sulfide encapsulating the precious metal, the method comprising leaching the precious metal from a residue comprising the precious metal as described above

In various embodiments, the sulfide comprises a metal sulfide. In various embodiments, the metal sulfide comprises a base metal sulfide. In various embodiments, the base metal sulfide comprises a copper sulfide, a nickel sulfide, or a cadmium sulfide.

In various embodiments, the leaching comprises contacting the residue with a lixiviant to extract the precious metal from the residue.

In various embodiments, the lixiviant comprises cyanide, thiosulfate, glycine, thiocyanate, chloride, a reagent comprising a thiocarbonyl functional group or iodine/iodide.

In various embodiments, the leaching comprises cyanidation.

In various embodiments, the lixiviant comprises a reagent comprising a thiocarbonyl functional group.

In various embodiments, prior to leaching, the use further comprises washing the residue comprising the precious metal.

In various embodiments, the leaching comprises a percolation leach, a tank leach, a vat leach or combinations thereof. In various embodiments, the percolation leach is a heap leach or a dump leach. In various embodiments, the leaching comprises a tank leach.

In various embodiments, the use further comprises recovering the precious metal. In various embodiments, the leaching produces a pregnant leach solution comprising the precious metal and the use further comprises recovering the precious metal from the pregnant leach solution. In various embodiments, the recovering comprises cementation, ion exchange, adsorption of the precious metal on carbon, reduction of the precious metal with a reducing agent, solvent extraction or recovering, electrowinning or combinations thereof. In various embodiments, the recovering comprises cementation. In various embodiments, the recovering comprises ion exchange. In various embodiments, the recovering comprises adsorption of the precious metal on carbon. In various embodiments, the recovering comprises reduction of the precious metal with a reducing agent. In various embodiments, the recovering comprises solvent extraction or recovering. In various embodiments, the recovering comprises electrowinning.

In various embodiments, the use comprises a solid-liquid separation.

In various embodiments, the use further comprises recovering the reagent comprising the thiocarbonyl functional group or the FDS. In various embodiments, the use further comprises recycling the recovered reagent comprising the thiocarbonyl functional group or FDS for use in the contacting of a further portion of the material and/or a further portion of the residue.

In various embodiments, the contacting is at ambient temperature and pressure. In various embodiments, the contacting is at ambient temperature. In various embodiments, the contacting is at a temperature of between about 0° C. to about 80° C. In various embodiments, the use the contacting is at a temperature of between about 5° C. to about 55° C. In various embodiments, the contacting is at a temperature of between about 15° C. to about 25° C.

In various embodiments, the contacting is at ambient pressure. In various embodiments, ambient pressure is about 1 atm.

In various embodiments, the use comprises a batch use. In various embodiments, the use comprises a continuous use.

Other features and advantages of the present disclosure will become apparent from the following detailed description. It should be understood, however, that the detailed description and the specific examples, while indicating embodiments of the disclosure, are given by way of illustration only and the scope of the claims should not be limited by these embodiments, but should rather be given the broadest interpretation consistent with the description as a whole.

### BRIEF DESCRIPTION OF THE DRAWINGS

The embodiments of the disclosure will now be described in greater detail with reference to the attached drawings, in which:

FIG. 1 is a graph showing the catalytic effect of thiourea on the bio-oxidation of a pyritic material containing 0.51 g/t gold, 35 g/t silver and 0.1% copper where gold recovery (%) is measured after bio-oxidation (front columns) and after cyanidation (rear columns) for a pre-treatment with thiourea (Tu; right columns) compared to a control process without thiourea (Control; left columns);

FIG. 2 is a graph showing the catalytic effect of thiourea on the bio-oxidation of the pyritic material containing 0.51 g/t gold, 35 g/t silver and 0.1% copper where silver recovery (%) is measured after bio-oxidation (front columns) and after cyanidation (rear columns) for a pre-treatment with thiourea (Tu; right columns) compared to a control process without thiourea (Control; left columns);

FIG. 3 is a graph showing the catalytic effect of thiourea on the bio-oxidation of the pyritic material containing 0.51 g/t of gold, 35 g/t silver and 0.1% copper where copper recovery (%) is measured after bio-oxidation (front columns) and after cyanidation (rear columns) for a pre-treatment with thiourea (Tu; right columns) compared to a control process without thiourea (Control; left columns); and

FIG. 4 is a graph showing the catalytic effect of pre-treatment with thiourea (0.2 mM per day) on the bio-oxidation of sulfides in pure arsenopyrite mineral (triangles) in comparison to a control process without thiourea (circles).

### DETAILED DESCRIPTION

### I. Definitions

Unless otherwise indicated, the definitions and embodiments described in this and other sections are intended to be applicable to all embodiments and aspects of the disclosure herein described for which they would be understood to be suitable by a person skilled in the art.

As used herein, the words “comprising” (and any form thereof, such as “comprise” and “comprises”), “having” (and any form thereof, such as “have” and “has”), “including” (and any form thereof, such as “include” and “includes”) or “containing” (and any form thereof, such as “contain” and “contains”), are inclusive or open-ended and do not exclude additional, unrecited elements or steps.

Terms of degree such as “substantially”, “about” and “approximately” as used herein mean a reasonable amount of deviation of the modified term such that the end result is not significantly changed. These terms of degree should be construed as including a deviation of at least ±5% and up to ±20% of the modified term if this deviation would not negate the meaning of the term it modifies.

As used in this disclosure, the singular forms “a”, “an” and “the” include plural references unless the content clearly dictates otherwise.

The term “and/or” as used herein means that the listed items are present, or used, individually or in combination. In effect, this term means that “at least one of” or “one or more” of the listed items is present or used.

The term “bacteria” as used herein may refer to a plurality of bacteria of a single species as well as a plurality of bacteria comprising multiple species of bacteria.

### II. Methods and Uses

A method and use of a reagent having a thiocarbonyl functional group for the liberation of precious metals from materials comprising a sulfide, wherein the sulfide encapsulates the precious metal, is described herein. Following such use of a reagent having a thiocarbonyl functional group, the precious metals can then be extracted, for example, using traditional methods such as cyanidation. The use of a reagent having a thiocarbonyl functional group for liberating precious metals is a pre-treatment performed, for example, before extraction. Traditional extraction methods in combination with the methods and uses comprising the liberation of precious metals using a reagent having a thiocarbonyl functional group yields greater precious metal recovery than the corresponding traditional extraction methods alone.

Accordingly, the present disclosure includes a method for liberating a precious metal from a material, the method comprising: contacting the material under acidic conditions with a reagent having a thiocarbonyl functional group, wherein the material comprises a sulfide encapsulating the precious metal.

The material is contacted with the reagent having the thiocarbonyl functional group by any suitable method. In an embodiment, the material is contacted with the reagent having the thiocarbonyl functional group by a method comprising: contacting the material with an acidic mixture comprising the reagent having the thiocarbonyl functional group.

The term “reagent having a thiocarbonyl functional group” as used herein refers to an organosulfur compound comprising a C═S functional group that can also be known in the art as a thione or thioketone. The reagent having the thiocarbonyl functional group can be any suitable reagent having a thiocarbonyl functional group. For example, suitable reagents having a thiocarbonyl functional group may feature a C═S functional group having a sulfur bearing a partial negative charge, bearing a negative electrostatic potential surface and having an empty π*-antibonding orbital as its lowest unoccupied molecular orbital (LUMO), provided that the reagent having the thiocarbonyl functional group is at least partially soluble in water and preferably does not significantly complex with the base metal (if present) and/or the oxidizing agent (if present) to form insoluble precipitates. Certain reagents having a thiocarbonyl functional group are capable of oxidizing to form the corresponding dimer. For example, thiourea, in the presence of a suitable oxidant such as ferric sulfate is capable of oxidizing to form the dimer formamidine disulfide (FDS). An equilibrium exists between FDS and thiourea in a ferric sulfate solution such that, for example, acidic conditions comprising a dimer of a reagent having a thiocarbonyl functional group (e.g. FDS) will provide the reagent having the thiocarbonyl functional group (e.g. thiourea) for contacting the material. Accordingly, in an embodiment, the reagent having the thiocarbonyl functional group is added to the method in the form of the corresponding dimer. In an alternative embodiment of the present disclosure, the reagent having the thiocarbonyl functional group is added to the method in monomeric form (i.e. in the form of the reagent having the thiocarbonyl functional group).

In an embodiment, the reagent having the thiocarbonyl functional group is devoid of thiourea. In another embodiment, the reagent having the thiocarbonyl functional group is N—N′ substituted thioureas; 2,5-dithiobiurea; dithiobiuret; thiosemicarbazide purum; thiosemicarbazide; thioacetamide; 2-methyl-3-thiosemicarbazide; 4-methyl-3-thiosemicarbazide; vinylene trithiocarbonate purum; vinylene trithiocarbonate; 2-cyanothioacetamide; ethylene trithiocarbonate; potassium ethyl xanthogenate; dimethylthiocarbamoyl chloride; dimethyldithiocarbamate; dimethyl trithiocarbonate; N,N-dimethylthioformamide; 4,4-dimethyl-3-thiosemicarbazide; 4-ethyl-3-thiosemicarbazide; O-isopropylxanthic acid; ethyl thiooxamate; ethyl dithioacetate; pyrazine-2-thiocarboxamide; diethylthiocarbamoyl chloride; diethyldithiocarbamate; tetramethylthiuram monosulfide; tetramethylthiuram disulfide; pentafluorophenyl chlorothionoformate; 4-fluorophenyl chlorothionoformate; O-phenyl chlorothionoformate; phenyl chlorodithioformate; 3,4-difluorothiobenzamide; 2-bromothiobenzamide; 3-bromothiobenzamide; 4-bromothiobenzamide; 4-chlorothiobenzamide; 4-fluorothiobenzamide; thiobenzoic acid; thiobenzamide; 4-phenylthiosemicarbazide; O-(p-tolyl) chlorothionoformate; 4-bromo-2-methylthiobenzamide; 3-methoxythiobenzamide; 4-methoxythiobenzamide; 4-methylbenzenethioamide; thioacetanilide; salicylaldehyde thiosemicarbazone; indole-3-thiocarboxamide; S-(thiobenzoyl)thioglycolic acid; 3-(acetoxy)thiobenzamide; 4-(acetoxy)thiobenzamide; methyl N′-[(e)-(4-chlorophenyl)methylidene]hydrazonothiocarbamate; 3-ethoxythiobenzamide; 4-ethylbenzene-1-thiocarboxamide; tert-butyl 3-[(methylsulfonyl)oxy]-1-azetanecarboxylate; diethyldithiocarbamic acid; 2-(phenylcarbonothioylthio)-propanoic acid; 2-hydroxybenzaldehyde N-ethylthiosemicarbazone; (1R,4R)-1,7,7-trimethylbicyclo[2.2.1]heptane-2-thione; tetraethylthiuram disulfide; 4′-hydroxybiphenyl-4-thiocarboxamide; 4-biphenylthioamide; dithizone; 4′-methylbiphenyl-4-thiocarboxamide; tetraisopropylthiuram disulfide; anthracene-9-thiocarboxamide; phenanthrene-9-thiocarboxamide; sodium dibenzyldithiocarbamate; 4,4′-bis(dimethylamino)thiobenzophenone; or combinations thereof. In an embodiment, the reagent having the thiocarbonyl functional group comprises thiourea, ethylene thiourea, thioacetamide, sodium dimethyldithiocarbamate, ethylene trithiocarbonate, thiosemicarbazide or combinations thereof. In another embodiment, the reagent having the thiocarbonyl functional group comprises thiourea. In another embodiment, the reagent having the thiocarbonyl functional group is thiourea (Tu). In another embodiment, the reagent having the thiocarbonyl functional group is thioacetamide (TA). In another embodiment, the reagent having the thiocarbonyl functional group is sodium-dimethyldithiocarbamate (SDDC). In another embodiment, the reagent having the thiocarbonyl functional group is ethylene trithiocarbonate (ETC). In another embodiment, the reagent having the thiocarbonyl functional group is thiosemicarbazide (TSCA).

The concentration of the reagent having the thiocarbonyl functional group in the acidic conditions can be any suitable concentration. For example, it will be appreciated by a person skilled in the art that the methods of the present disclosure comprise liberation of the precious metal from the material comprising the sulfide through the reagent having the thiocarbonyl functional group acting as a catalyst for the oxidation of the sulfide without substantial reaction of the reagent having the thiocarbonyl functional group with the precious metal. The reagent having the thiocarbonyl functional group is not used to leach (e.g. oxidize and complex) the precious metal e.g. gold. Precious metals are suitably liberated from the material using low concentrations of the reagent having the thiocarbonyl functional group. In addition, since the regent having the thiocarbonyl functional group is not used as a lixiviant to complex with the precious metal, its concentration does not typically need to be adjusted to correlate with the precious metal content in the material. The reagent having the thiocarbonyl functional group liberates precious metals irrespective of the identity of the precious metal and/or concentration of the precious metal in the material because the reagent having the thiocarbonyl functional group acts on the sulfide encapsulating the precious metal.

In embodiments wherein the reagent having the thiocarbonyl functional group is referred to as being added to the method in the form of the corresponding dimer, the concentrations specified herein for the reagent having the thiocarbonyl functional group refers to a concentration calculated as if all of the dimer was dissociated into the reagent having the thiocarbonyl functional group. In an embodiment, the reagent having the thiocarbonyl functional group is present in the acidic conditions at a concentration of about 50 mM or lower. In another embodiment, the reagent having the thiocarbonyl functional group is present in the acidic conditions at a concentration of about 30 mM or lower. In another embodiment, the reagent having the thiocarbonyl functional group is present in the acidic conditions at a concentration of about 20 mM or lower. In some embodiments, a lower concentration of the reagent having the thiocarbonyl functional group is used. Accordingly, in another embodiment, the reagent having the thiocarbonyl functional group is present in the acidic conditions at a concentration of about 10 mM or lower, about 5 mM or lower, about 2 mM or lower, about 1.5 mM or lower, about 1.0 mM or lower, about 0.9 mM or lower, about 0.8 mM or lower, about 0.7 mM or lower, about 0.6 mM or lower, about 0.5 mM or lower, about 0.4 mM or lower, about 0.3 mM or lower, about 0.2 mM or lower, about 0.02 mM or lower, or about 0.002 mM. It will be appreciated by a person skilled in the art that such embodiments can be interchanged in any suitable manner. For example, in another embodiment, the reagent having the thiocarbonyl functional group is present in the acidic conditions at a concentration of from about 0.002 mM to about 50 mM, about 0.002 mM to about 30 mM, about 0.002 mM to about 20 mM, about 0.002 mM to about 10 mM, about 0.002 mM to about 5 mM, about 0.002 mM to about 2 mM, about 0.002 mM to about 1 mM, about 0.002 mM to about 0.2 mM, about 0.002 mM to about 0.02 mM, about 0.02 mM to about 50 mM, about 0.02 mM to about 30 mM, about 0.02 mM to about 20 mM, about 0.02 mM to about 10 mM, about 0.02 mM to about 5 mM, about 0.02 mM to about 2 mM, about 0.02 mM to about 1 mM, about 0.02 mM to about 0.2 mM, about 0.2 mM to about 50 mM, about 0.2 mM to about 30 mM, about 0.2 mM to about 20 mM, about 0.2 mM to about 10 mM, about 0.2 mM to about 5 mM, about 0.2 mM to about 2 mM, about 0.2 mM to about 1 mM, about 2 mM to about 50 mM, about 2 mM to about 30 mM, about 2 mM to about 20 mM, about 2 mM to about 10 mM, about 2 mM to about 4 mM, about 10 mM to about 50 mM, about 10 mM to about 30 mM, about 10 mM to about 20 mM, or about 30 mM to about 50 mM.

The present disclosure also includes a method for liberating a precious metal from a material, the method comprising: contacting the material under acidic conditions with formamidine disulfide (FDS), wherein the material comprises a sulfide encapsulating the precious metal. The material is contacted with the FDS by any suitable method. In an embodiment, the material is contacted with the FDS by a method comprising: contacting the material with an acidic mixture comprising the FDS.

The concentration of the FDS in the acidic conditions can be any suitable concentration. The concentrations specified hereinbelow for FDS refer to a concentration calculated as if no FDS was dissociated into thiourea. In an embodiment, the FDS is present in the acidic conditions at a concentration of about 25 mM or lower. In another embodiment, the FDS is present in the acidic conditions at a concentration of about 15 mM or lower. In another embodiment, the FDS is present in the acidic conditions at a concentration of about 10 mM or lower. In some embodiments, a lower concentration of the FDS is used. Accordingly, in another embodiment, the FDS is present in the acidic conditions at a concentration of about 5 mM or lower, about 2.5 mM or lower, about 1 mM or lower, about 0.75 mM or lower, about 0.5 mM or lower, about 0.45 mM or lower, about 0.4 mM or lower, about 0.35 mM or lower, about 0.3 mM or lower, about 0.25 mM or lower, about 0.2 mM or lower, about 0.15 mM or lower, about 0.1 mM or lower, about 0.01 mM or lower, or about 0.001 mM. It will be appreciated by a person skilled in the art that such embodiments can be interchanged in any suitable manner. For example, in another embodiment, the FDS is present in the acidic conditions at a concentration of from about 0.001 mM to about 25 mM, about 0.001 mM to about 15 mM, about 0.001 mM to about 10 mM, about 0.001 mM to about 5 mM, about 0.001 mM to about 2.5 mM, about 0.001 mM to about 1 mM, about 0.001 mM to about 0.5 mM, about 0.001 mM to about 0.1 mM, about 0.001 mM to about 0.01 mM, about 0.01 mM to about 25 mM, about 0.01 mM to about 15 mM, about 0.01 mM to about 10 mM, about 0.01 mM to about 5 mM, about 0.01 mM to about 2.5 mM, about 0.01 mM to about 1 mM, about 0.01 mM to about 0.5 mM, about 0.01 mM to about 0.1 mM, about 0.1 mM to about 25 mM, about 0.1 mM to about 15 mM, about 0.1 mM to about 10 mM, about 0.1 mM to about 5 mM, about 0.1 mM to about 2.5 mM, about 0.1 mM to about 1 mM, about 0.1 mM to about 0.5 mM, about 1 mM to about 25 mM, about 1 mM to about 15 mM, about 1 mM to about 10 mM, about 1 mM to about 5 mM, about 1 mM to about 2 mM, about 5 mM to about 25 mM, about 5 mM to about 15 mM, about 5 mM to about 10 mM, or about 15 mM to about 25 mM.

In an embodiment, the material is agglomerated prior to contact. Methods for agglomerating are well known in the art and a suitable method for agglomeration can be selected by the skilled person.

In some embodiments, the acidic conditions further comprise an oxidizing agent. For example, in some embodiments, the acidic mixture further comprises an oxidizing agent. The oxidizing agent can be any suitable oxidizing agent or combination thereof, the selection of which can be made by a person skilled in the art. In an embodiment, the oxidizing agent comprises oxygen, a source of Fe³⁺ ions or combinations thereof. In another embodiment, the oxidizing agent comprises a source of Fe³⁺ (ferric) ions or iron. The term “source” as used herein in reference to Fe³⁺ ions may include both direct sources of Fe³⁺ ions and indirect sources of Fe³⁺ ions, as appropriate. The term “direct source” as used herein in reference to a source of Fe³⁺ ions refers to a substance such as a suitable water-soluble iron(III) salt that directly releases the Fe³⁺ ions upon dissolution in an aqueous environment such as the acidic mixtures of the present disclosure. The term “indirect source” as used herein in reference to a source of Fe³⁺ ions refers to a source such as a suitable water soluble iron(II) salt that releases a substance such as Fe²⁺ ions upon dissolution in an aqueous environment such as the acidic conditions or acidic mixtures of the present disclosure that can be converted into the Fe³⁺ ions e.g. by an electrochemical process. For example, the oxidizing agent can comprise a water-soluble salt such as ferric sulfate (also known as iron (III) sulfate or Fe₂(SO₄)₃) that can act as a direct source of Fe³⁺ ions and/or a water-soluble salt such as ferrous sulfate (also known as iron (II) sulfate or FeSO₄) that acts as a direct source of Fe²⁺ ions that can, for example, be oxidized into Fe³⁺ ions e.g. by iron-oxidizing bacteria. In some embodiments, indirect sources of Fe³⁺ ions may also comprise suitable iron sludges. In another embodiment, the oxidizing agent comprises ferric sulfate. In another embodiment, the source of ferric ions comprises ferric ions generated at least in part by iron-oxidizing bacteria. In an embodiment, the acidic conditions or acidic mixture comprise a ferric solution. In another embodiment, the acidic conditions or acidic mixture comprise a ferric sulfate solution. In a further embodiment, the acidic conditions or acidic mixture comprise a ferric media. In another embodiment, the acidic conditions or acidic mixture comprise a ferrous sulfate solution. In another embodiment, the ferrous sulfate solution provides a source of Fe²⁺ ions that are oxidized to Fe³⁺ ions by iron-oxidizing bacteria. The concentration of the oxidizing agent such as ferric sulfate in the acidic conditions or acidic mixture can be any suitable concentration. In an embodiment, prior to the material being contacted with the reagent having the thiocarbonyl functional group, the oxidizing agent e.g. ferric sulfate is present in the acidic conditions or acidic mixture at a concentration of less than 10 g/L of Fe³⁺. In another embodiment, prior to the material being contacted with the reagent having the thiocarbonyl functional group, the oxidizing agent e.g. ferric sulfate is present in the acidic conditions or acidic mixture at a concentration of from about 0.5 g/L to about 20 g/L, about 1.5 g/L to about 3 g/L or about 2 g/L to about 2.5 g/L of Fe³⁺.

In some embodiments, during the contact, the method further comprises bio-oxidation of the material. The term “bio-oxidation” as used herein refers to a process in which the sulfide is oxidized by suitable microbes such as a bacteria or combination (consortium) thereof without significant solubilization of the precious metal. The selection of suitable microbes can be made by a person skilled in the art. Suitable microbes are, for example, capable of oxidizing reduced forms of sulfur and similar species in the sulfide and optionally other species such as Fe²⁺ ions. Accordingly, in some embodiments, the material further comprises sulfur-oxidizing bacteria, iron-oxidizing bacteria, bacteria that are sulfur-oxidizing and iron-oxidizing or combinations thereof. In some embodiments, the sulfur-oxidizing bacteria, iron-oxidizing bacteria, bacteria that are sulfur-oxidizing and iron-oxidizing or combinations thereof are added to the acidic conditions, for example, the acidic mixture further comprises sulfur-oxidizing bacteria, iron-oxidizing bacteria, bacteria that are sulfur-oxidizing and iron-oxidizing or combinations thereof. In an embodiment, the bacteria are sulfur-oxidizing. In another embodiment, the bacteria are iron-oxidizing. In an embodiment, the bacteria are sulfur-oxidizing and iron-oxidizing. In an embodiment, the bacteria that are sulfur-oxidizing and iron-oxidizing comprise Acidothiobacilos ferrooxidans.

The term “sulfide” as used herein refers to a component, mineral or combinations of minerals or components comprising sulfide (S²⁻) or persulfide (S₂²⁻) as an anion and also includes the selenides, tellurides, arsenides, antimonides, bismuthinides, the sulfarsenides and sulfosalts. In an embodiment, the sulfide comprises a sulfide mineral. In some embodiments, the material comprising a sulfide is a material comprising a sulfide mineral. In some embodiments, the sulfide mineral is broken down by the oxidation of sulfides that is catalyzed by the reagent having the thiocarbonyl functional group. In an embodiment, the sulfide comprises sulfur, iron, arsenic, antimony or combinations thereof; i.e. it will be appreciated by the person skilled in the art that such species are in a suitable ionic form for the particular sulfide in which they are comprised. In an embodiment, sulfide comprises sulfur. In another embodiment, the sulfide comprises iron. In another embodiment, the sulfide comprises arsenic. In another embodiment, the sulfide comprises antimony. In another embodiment, the sulfide comprises pyrite, arsenian pyrite, marcasite, arsenopyrite, pyrrhotite, enargite, bornite, chalcopyrite or combinations thereof. In a further embodiment, the sulfide comprises pyrite. In another embodiment, the sulfide comprises arsenian pyrite. In another embodiment, the sulfide comprises marcasite. In another embodiment, the sulfide comprises arsenopyrite. In another embodiment, the sulfide comprises pyrrhotite. In another embodiment, the sulfide comprises enargite. In another embodiment, the sulfide comprises bornite. In another embodiment, the sulfide comprises chalcopyrite. In another embodiment, the sulfide comprises pyrite, arsenian pyrite, arsenopyrite, or combinations thereof.

The term “precious metal” as used herein refers to any suitable metal or combination thereof that does not comprise a base metal (e.g. copper or iron (Fe)). For example, suitable precious metals may include but are not limited to a platinum group metal, gold, silver or combinations thereof. The term “platinum group metal” as used herein refers to ruthenium, rhodium, palladium, osmium, iridium and/or platinum. In an embodiment, the precious metal comprises a platinum group metal, gold, silver or combinations thereof. In another embodiment, the precious metal comprises gold. In a further embodiment, the precious metal comprises silver. In another embodiment, the precious metal comprises a platinum group metal. In another embodiment, the precious metal comprises platinum. In another embodiment, the precious metal comprises gold, silver or combinations thereof. In another embodiment, the precious metal comprises a combination of gold and silver.

In an embodiment, the material further comprises a base metal. The base metal may be comprised in the sulfide, in another mineral or combination thereof in the material or combinations thereof. The term “base metal” as used herein refers to any suitable metal or combination thereof that does not comprise a precious metal (e.g. gold). For example, suitable base metals may include but are not limited to copper, nickel, iron, aluminum, lead, zinc, tin, tungsten (also sometimes referred to as wolfram), molybdenum, tantalum, magnesium, cobalt, bismuth, cadmium, titanium, zirconium, antimony, manganese, beryllium, chromium, germanium, vanadium, gallium, hafnium, indium, niobium (also sometimes referred to as columbium), rhenium, thallium and combinations thereof. In an embodiment, the base metal comprises copper, nickel, zinc or combinations thereof. In another embodiment, the base metal comprises copper. In an embodiment, the base metal is comprised in a base metal sulfide ore. In an embodiment, the copper is comprised in a copper sulfide ore. In another embodiment, the copper sulfide ore is a primary copper sulfide (e.g. chalcopyrite, bornite, enargite or combinations thereof), a secondary copper sulfide (e.g. covellite, chalcocite or combinations thereof) or combinations thereof. In an embodiment, the copper sulfide ore comprises a primary copper sulfide. In another embodiment, the copper sulfide ore comprises a secondary copper sulfide. In a further embodiment, the copper sulfide ore comprises a combination of a primary copper sulfide and a secondary copper sulfide. In another embodiment, the copper sulfide ore comprises chalcopyrite, bornite, enargite, covellite, chalcocite, a copper sulfide of the formula CuₓS_{y} wherein the x:y ratio is between 1 and 2 or combinations thereof. In an embodiment, the copper sulfide of the formula CuₓS_{y} wherein the x:y ratio is between 1 and 2 is chalcocite, djurleite, digenite or combinations thereof. In another embodiment, the copper sulfide ore comprises chalcopyrite. Base metal sulfide ores other than copper sulfide ores are well known to the person skilled in the art. In an embodiment, the material comprises a nickel sulfide ore. In another embodiment, the nickel sulfide ore comprises pentlandite, violarite or combinations thereof.

The acidic conditions are any suitable acidic conditions, the selection of which can be made by a person skilled in the art. In some embodiments, the method comprises adding an acid to obtain the acidic conditions. In another embodiment, the acid added to obtain the acidic conditions comprises sulfuric acid. In an embodiment, pH of the acidic conditions is in a range of from about 0 to about 6.5, about 0.5 to about 4, about 1 to about 3, or about 1.5 to about 2.5. In another embodiment, the pH of the acidic conditions is about 2.

The molar ratio of the reagent having the thiocarbonyl functional group to ferric (Fe³⁺) ions in the acidic mixture is any suitable ratio. In an embodiment, the molar ratio of the reagent having the thiocarbonyl functional group to ferric (Fe³⁺) ions is less than about 0.25.

The contacting can be carried out using any suitable method and/or means, the selection of which can be made by a person skilled in the art. In an embodiment, the contacting comprises a method comprising a percolation (e.g. in a heap, a dump or a column), a tank, a vat, a bioreactor or combinations thereof. In an embodiment, the contacting comprises a method comprising a percolation (e.g. in a heap, a dump or a column), a tank, a vat or combinations thereof. In another embodiment, the method comprising a percolation is a method comprising a heap or a dump. In an embodiment, the contacting comprises a method comprising a percolation. In another embodiment, the contacting comprises a method comprising a heap. In another embodiment, the contacting comprises a method comprising a dump. In another embodiment, the contacting comprises a method comprising a column. In another embodiment, the contacting comprises a method comprising a tank. In another embodiment, the contacting comprises a method comprising a vat. In another embodiment, the contacting comprises a method comprising a bioreactor. Suitable methods, means and/or conditions for carrying out the contacting in a percolation (e.g. in a heap, a dump or a column), a tank, a vat or a bioreactor in the methods of the present disclosure can be selected by the person skilled in the art.

For example, the term “method comprising a percolation” and the like as used herein refers to a method in which the precious metal is liberated from the material by acidic conditions seeping into and flowing through a mass of the material. In some embodiments of the present disclosure, the precious metal is liberated from the material by causing the acidic conditions, such as an acidic mixture to seep into and flow through a mass of the material that is agglomerated.

The term “method comprising a heap” and the like as used herein refers to an example of a method comprising a percolation which comprises heaping or stacking the material onto a heap pad (e.g. an impermeable plastic or clay-lined pad), and contacting (e.g. irrigating via a means such as a sprinkler or drip irrigation) the heaped material with the acidic conditions in a way such that the acidic conditions percolate through the heap. In methods comprising a heap, the material is typically crushed subsequent to being removed from the ground and prior to being heaped. In an embodiment, the crushing is primary crushing. In another embodiment, the crushing is secondary crushing. In a further embodiment, the crushing is tertiary crushing. It will be appreciated by the person skilled in the art that in embodiments wherein the material is agglomerated, such agglomeration is carried out prior to the material being heaped, and, in embodiments comprising crushing the material, subsequent to the crushing of the material.

The term “method comprising a dump” and the like as used herein refers to an example of a method comprising a percolation having a method that is similar to that comprising a heap, but wherein the material is not crushed prior to being stacked on the leach pad.

The term “method comprising a column” and the like as used herein refers to an example of a method comprising a percolation which comprises loading the material into a column then contacting (e.g. irrigating via a means such as drip irrigation from the top of the column) the material with the acidic conditions in a way such that the acidic conditions percolate through the material. In some embodiments, the material is crushed prior to being loaded in the column. It will be appreciated by the person skilled in the art that in embodiments wherein the material is agglomerated, such agglomeration is carried out prior to the material being loaded, and, in embodiments comprising crushing the material, subsequent to the crushing of the material. Columns can be useful, for example, for measuring the effects of typical variables encountered in industrial methods and uses comprising a heap and/or a dump.

The term “method comprising a tank” and the like and “method comprising a vat” and the like as used herein refer to methods in which the material is placed into a tank or vat, respectively, containing the acidic conditions under conditions suitable to liberate the precious metal. In exemplary methods comprising a tank, the material is typically ground to a fineness suitable to form a slurry or pulp, combined with water to form the slurry or pulp then pumped into the tank where subsequently the acidic conditions are added. In exemplary methods comprising a vat, a coarser particle size of the material is used which is loaded into the vat as a solid, then the acidic conditions are flooded into the vat.

The person skilled in the art will appreciate that the terms “acidic conditions” and “acidic mixture” and the like as used herein include an acidic solution, an acidic aqueous solution and/or other forms of acidic aqueous conditions and mixtures, the identity of which may depend, for example, on the nature and/or concentration of the components comprised therein. The acidic conditions and acidic mixtures used in the various embodiments of the present disclosure can readily be prepared by the person skilled in the art having regard to the present disclosure by combining the various components therein by a suitable methods and/or means. For example, in some embodiments comprising the oxidizing agent (such as ferric sulfate), the acidic mixture can be prepared by a method comprising adjusting the pH of an aqueous solution comprising the desired amount of the oxidizing agent (such as ferric sulphate) with a suitable acid (such as sulfuric acid) to a suitable value (such as a pH of about 2) to obtain an acidic aqueous solution comprising the oxidizing agent, then adding the desired amount of the reagent having the thiocarbonyl functional group (or dimer thereof) to obtain the acidic mixture.

In an embodiment, the contacting produces a residue comprising the precious metal. In another embodiment, subsequent to contact, the method further comprises pressure oxidation to produce a residue comprising the precious metal.

In some embodiments, the method further comprises leaching the precious metal from the residue comprising the precious metal so as to extract the precious metal from the material.

Accordingly, the present disclosure also includes a method for extracting a precious metal from a material comprising a sulfide encapsulating the precious metal, the method comprising a method as described herein for liberating a precious metal from a material, wherein the material comprises a sulfide encapsulating the precious metal, the method comprising contacting the material under acidic conditions with a reagent having a thiocarbonyl functional group wherein the contacting produces a residue comprising the precious metal; and leaching the precious metal from the residue comprising the precious metal.

The leaching can comprise any suitable method and/or means for leaching the precious metal from the residue, the selection of which can be made by the person skilled in the art. In an embodiment, the leaching comprises contacting the residue with a lixiviant to extract the precious metal from the residue. It will be appreciated by a person skilled in the art that a suitable lixiviant may, for example, depend on the identity of the precious metal and/or other components (e.g. base metals) in the material and the skilled person can readily select a suitable lixiviant accordingly. In an embodiment, the lixiviant comprises cyanide, thiosulfate, glycine, thiocyanate, chloride, a reagent having a thiocarbonyl functional group or iodine/iodide. In another embodiment, the leaching comprises cyanidation. In a further embodiment, the lixiviant comprises a reagent having a thiocarbonyl functional group. In an embodiment, the leaching is carried out in a method comprising a percolation leach (e.g. in a heap leach, a dump leach or a column leach), a tank leach, a vat leach, a bioreactor or combinations thereof. In an embodiment, the leaching is carried out in a method comprising a percolation leach (e.g. in a heap leach, a dump leach or a column leach), a tank leach, a vat leach or combinations thereof. In another embodiment, the percolation leach is a heap leach or a dump leach. In an embodiment, the leaching is carried out in a method comprising a percolation leach. In another embodiment, the leaching is carried out in a method comprising a heap leach. In another embodiment, the leaching is carried out in a method comprising a dump leach. In another embodiment, the leaching is carried out in a method comprising a column leach. In another embodiment, the leaching is carried out in a method comprising a tank leach. In another embodiment, the leaching is carried out in a method comprising a vat leach. In another embodiment, the leaching is carried out in a method comprising a bioreactor. Suitable methods, means and/or conditions for carrying out the leaching in a percolation leach (e.g. in a heap leach, a dump leach or a column leach), a tank leach, a vat leach or a bioreactor in the methods of the present disclosure can be selected by the person skilled in the art.

For example, the term “percolation leach” as used herein refers to a method in which the precious metal is leached from the residue by causing the lixiviant to seep into and flow through a mass of the residue.

The term “heap leach” as used herein refers to an example of a percolation leach which comprises heaping or stacking the residue onto a heap leach pad (e.g. an impermeable plastic or clay-lined leach pad), and contacting (e.g. irrigating via a means such as a sprinkler or drip irrigation) the heaped residue with the lixiviant in a way such that the lixiviant percolates through the heap and leaches the precious metal, for example, so as to obtain a pregnant leach solution comprising the precious metal which can be collected.

The term “dump leach” as used herein refers to an example of a percolation leach having a method that is similar to a heap leach, but wherein the residue has not been crushed prior to being stacked on the leach pad.

The term “column leach” as used herein refers to an example of a percolation leach which comprises loading the residue into a column then contacting (e.g. irrigating via a means such as drip irrigation from the top of the column) the residue with the lixiviant in away such that the lixiviant percolates through the residue in the column and leaches the precious metal, for example, so as to obtain a pregnant leach solution comprising the precious metal which can be collected. Column leaches can be useful, for example, for measuring the effects of typical variables encountered in industrial heap and/or dump leaching methods.

The terms “tank leach” and “vat leach” as used herein refer to methods in which the residue is placed into a tank or vat, respectively, containing the lixiviant under conditions suitable to leach the precious metal, for example, to obtain a pregnant leach solution comprising the precious metal which can be collected. In exemplary tank leaching methods, the residue has typically been ground to a fineness suitable to form a slurry or pulp, combined with water to form the slurry or pulp then pumped into the tank where subsequently the lixiviant is added. In exemplary vat leaching methods, a coarser particle size of the residue is used which is loaded into the vat as a solid, then the lixiviant is flooded into the vat.

In some embodiments, the contacting and the leaching are carried out using the same means; for example, the contact is carried out in a method comprising a heap and the leaching is carried out using a heap leach. In alternative embodiments, the contacting and the leaching are carried out using different means; for example, the contact is carried out in a method comprising a heap and the leaching is carried out using a tank leach. Any suitable combination of means as described herein can be used and selected by the person skilled in the art.

In an embodiment, prior to leaching, the method further comprises washing the residue comprising the precious metal.

In an embodiment, the method further comprises recovering the precious metal. In another embodiment, the leaching produces a pregnant leach solution comprising the precious metal. In an embodiment, the leaching produces a pregnant leach solution comprising the precious metal and the method further comprises recovering the precious metal from the pregnant leach solution. In embodiments wherein the method comprises recovering the precious metal (e.g. from the pregnant leach solution), the method for recovering the precious metal can be any suitable method, the selection of which can be made by the person skilled in the art. It will be appreciated by a person skilled in the art that methods for recovery of the precious metal may depend, for example, on the method used for leaching and/or the nature of the precious metal(s) being recovered and can readily select a suitable means and/or method for recovery of the precious metal. In an embodiment, the recovering comprises cementation, ion exchange, adsorption of the precious metal on carbon, reduction of the precious metal with a reducing agent, solvent extraction or recovering, electrowinning or combinations thereof. In an embodiment, the cementation comprises Merrill-Crowe precipitation (zinc dust cementation). In an embodiment, the adsorption of the precious metal is on activated carbon or charcoal. In another embodiment, prior to the recovering, the method further comprises a solid-liquid separation.

In another embodiment, the method further comprises recovering the reagent having the thiocarbonyl functional group or the FDS, as the case may be. For example, the reagent having the thiocarbonyl functional group or the FDS can be recovered subsequent to contact with the material and/or in embodiments wherein the leaching comprises use of a reagent having a thiocarbonyl functional group, the reagent having the thiocarbonyl functional group can be recovered from the pregnant leach solution. In some embodiments, the method optionally further comprises recycling the recovered reagent having the thiocarbonyl functional group or the FDS for use in the contacting of a further portion of the material and/or for use in leaching such as for use in contacting with a further portion of the residue, as the case may be. In some embodiments, additional reagent having a thiocarbonyl functional group (or dimer thereof) is added to reach a desired concentration prior to the contacting with the material and/or prior to the leaching. In some embodiments, a reducing agent is added prior to the contacting with the material and/or prior to the leaching. The term “reducing agent” as used herein refers to any suitable reagent (e.g. a compound, element, ion or combination thereof) capable of providing electrons to the species being reduced. In an embodiment, the reducing agent may be, for example, H₂S, NaSH or Zn. In an embodiment, the reducing agent is added in an amount to obtain a ratio of reagent having a thiocarbonyl functional group (e.g. thiourea):corresponding dimer (e.g. FDS) in a range of about 0.5:1 to about 9:1.

The contacting is carried out under any suitable temperature and pressure conditions. For example, the contacting can be carried out at a temperature greater than 0° C. to about 80° C. However, the contacting in the methods of the present disclosure is advantageously carried out at ambient temperature (e.g. from about 5° C. to about 55° C. or about 15° C. to about 25° C.) and pressure (e.g. about 1 atm). In an embodiment, the contact is at ambient temperature and pressure. In another embodiment, the contact is at ambient temperature. In another embodiment, the contact is at ambient pressure. The leaching is also carried out under any suitable temperature and pressure conditions, the selection of which can be made by a person skilled in the art.

In an embodiment, the method is a batch method.

In an embodiment, the method is a continuous method.

The present disclosure also includes a use of a reagent having a thiocarbonyl functional group in a method for liberating a precious metal from a material, wherein the material comprises a sulfide encapsulating the precious metal. In an embodiment, the method is any method for liberating a precious metal from a material, comprising contacting the material under acidic conditions with the reagent having a thiocarbonyl functional group as described herein.

The present disclosure also includes a use of formamidine disulfide (FDS) in a method for liberating a precious metal from a material, wherein the material comprises a sulfide encapsulating the precious metal. In an embodiment, the method is any method for liberating a precious metal from a material, comprising contacting the material under acidic conditions with the formamidine disulfide (FDS) as described herein.

The present disclosure also includes a use of a reagent having a thiocarbonyl functional group for liberating a precious metal from a material, wherein the material comprises a sulfide encapsulating the precious metal; and wherein the material is contacted under acidic conditions with the reagent having the thiocarbonyl functional group.

The material is contacted with the reagent having the thiocarbonyl functional group by any suitable method. In an embodiment, the material is contacted with the reagent having the thiocarbonyl functional group by a method comprising: contacting the material with an acidic mixture comprising the reagent having the thiocarbonyl functional group.

In an embodiment, the reagent having the thiocarbonyl functional group is added to the method in the form of the corresponding dimer. In an alternative embodiment of the present disclosure, the reagent having the thiocarbonyl functional group is added to the method in monomeric form (i.e. in the form of the reagent having the thiocarbonyl functional group).

In an embodiment, the reagent having the thiocarbonyl functional group is devoid of thiourea. In another embodiment, the reagent having the thiocarbonyl functional group is N—N′ substituted thioureas; 2,5-dithiobiurea; dithiobiuret; thiosemicarbazide purum; thiosemicarbazide; thioacetamide; 2-methyl-3-thiosemicarbazide; 4-methyl-3-thiosemicarbazide; vinylene trithiocarbonate purum; vinylene trithiocarbonate; 2-cyanothioacetamide; ethylene trithiocarbonate; potassium ethyl xanthogenate; dimethylthiocarbamoyl chloride; dimethyldithiocarbamate; dimethyl trithiocarbonate; N,N-dimethylthioformamide; 4,4-dimethyl-3-thiosemicarbazide; 4-ethyl-3-thiosemicarbazide; O-isopropylxanthic acid; ethyl thiooxamate; ethyl dithioacetate; pyrazine-2-thiocarboxamide; diethylthiocarbamoyl chloride; diethyldithiocarbamate; tetramethylthiuram monosulfide; tetramethylthiuram disulfide; pentafluorophenyl chlorothionoformate; 4-fluorophenyl chlorothionoformate; O-phenyl chlorothionoformate; phenyl chlorodithioformate; 3,4-difluorothiobenzamide; 2-bromothiobenzamide; 3-bromothiobenzamide; 4-bromothiobenzamide; 4-chlorothiobenzamide; 4-fluorothiobenzamide; thiobenzoic acid; thiobenzamide; 4-phenylthiosemicarbazide; O-(p-tolyl) chlorothionoformate; 4-bromo-2-methylthiobenzamide; 3-methoxythiobenzamide; 4-methoxythiobenzamide; 4-methylbenzenethioamide; thioacetanilide; salicylaldehyde thiosemicarbazone; indole-3-thiocarboxamide; S-(thiobenzoyl)thioglycolic acid; 3-(acetoxy)thiobenzamide; 4-(acetoxy)thiobenzamide; methyl N′-[(e)-(4-chlorophenyl)methylidene]hydrazonothiocarbamate; 3-ethoxythiobenzamide; 4-ethylbenzene-1-thiocarboxamide; tert-butyl 3-[(methylsulfonyl)oxy]-1-azetanecarboxylate; diethyldithiocarbamic acid; 2-(phenylcarbonothioylthio)-propanoic acid; 2-hydroxybenzaldehyde N-ethylthiosemicarbazone; (1R,4R)-1,7,7-trimethylbicyclo[2.2.1]heptane-2-thione; tetraethylthiuram disulfide; 4′-hydroxybiphenyl-4-thiocarboxamide; 4-biphenylthioamide; dithizone; 4′-methylbiphenyl-4-thiocarboxamide; tetraisopropylthiuram disulfide; anthracene-9-thiocarboxamide; phenanthrene-9-thiocarboxamide; sodium dibenzyldithiocarbamate; 4,4′-bis(dimethylamino)thiobenzophenone; or combinations thereof. In an embodiment, the reagent having the thiocarbonyl functional group comprises thiourea, ethylene thiourea, thioacetamide, sodium dimethyldithiocarbamate, ethylene trithiocarbonate, thiosemicarbazide or combinations thereof. In another embodiment, the reagent having the thiocarbonyl functional group comprises thiourea. In another embodiment, the reagent having the thiocarbonyl functional group is thiourea (Tu). In another embodiment, the reagent having the thiocarbonyl functional group is thioacetamide (TA). In another embodiment, the reagent having the thiocarbonyl functional group is sodium-dimethyldithiocarbamate (SDDC). In another embodiment, the reagent having the thiocarbonyl functional group is ethylene trithiocarbonate (ETC). In another embodiment, the reagent having the thiocarbonyl functional group is thiosemicarbazide (TSCA).

The concentration of the reagent having the thiocarbonyl functional group in the acidic conditions can be any suitable concentration. For example, it will be appreciated by a person skilled in the art that the uses of the present disclosure comprise liberation of the precious metal from the material comprising the sulfide through the reagent having the thiocarbonyl functional group acting as a catalyst for the oxidation of the sulfide without substantial reaction of the reagent having the thiocarbonyl functional group with the precious metal. The reagent having the thiocarbonyl functional group is not used to leach (e.g. oxidize and complex) the precious metal e.g. gold. Precious metals are suitably liberated from the material using low concentrations of the reagent having the thiocarbonyl functional group. In addition, since the regent having the thiocarbonyl functional group is not used as a lixiviant to complex with the precious metal, its concentration does not typically need to be adjusted to correlate with the precious metal content in the material. The reagent having the thiocarbonyl functional group liberates precious metals irrespective of the identity of the precious metal and/or concentration of the precious metal in the material because the reagent having the thiocarbonyl functional group acts on the sulfide encapsulating the precious metal.

In embodiments wherein the reagent having the thiocarbonyl functional group is referred to as being added in the form of the corresponding dimer, the concentrations specified herein for the reagent having the thiocarbonyl functional group refers to a concentration calculated as if all of the dimer was dissociated into the reagent having the thiocarbonyl functional group. In an embodiment, the reagent having the thiocarbonyl functional group is present in the acidic conditions at a concentration of about 50 mM or lower. In another embodiment, the reagent having the thiocarbonyl functional group is present in the acidic conditions at a concentration of about 30 mM or lower. In another embodiment, the reagent having the thiocarbonyl functional group is present in the acidic conditions at a concentration of about 20 mM or lower. In some embodiments, a lower concentration of the reagent having the thiocarbonyl functional group is used. Accordingly, in another embodiment, the reagent having the thiocarbonyl functional group is present in the acidic conditions at a concentration of about 10 mM or lower, about 5 mM or lower, about 2 mM or lower, about 1.5 mM or lower, about 1.0 mM or lower, about 0.9 mM or lower, about 0.8 mM or lower, about 0.7 mM or lower, about 0.6 mM or lower, about 0.5 mM or lower, about 0.4 mM or lower, about 0.3 mM or lower, about 0.2 mM or lower, about 0.02 mM or lower, or about 0.002 mM. It will be appreciated by a person skilled in the art that such embodiments can be interchanged in any suitable manner. For example, in another embodiment, the reagent having the thiocarbonyl functional group is present in the acidic conditions at a concentration of from about 0.002 mM to about 50 mM, about 0.002 mM to about 30 mM, about 0.002 mM to about 20 mM, about 0.002 mM to about 10 mM, about 0.002 mM to about 5 mM, about 0.002 mM to about 2 mM, about 0.002 mM to about 1 mM, about 0.002 mM to about 0.2 mM, about 0.002 mM to about 0.02 mM, about 0.02 mM to about 50 mM, about 0.02 mM to about 30 mM, about 0.02 mM to about 20 mM, about 0.02 mM to about 10 mM, about 0.02 mM to about 5 mM, about 0.02 mM to about 2 mM, about 0.02 mM to about 1 mM, about 0.02 mM to about 0.2 mM, about 0.2 mM to about 50 mM, about 0.2 mM to about 30 mM, about 0.2 mM to about 20 mM, about 0.2 mM to about 10 mM, about 0.2 mM to about 5 mM, about 0.2 mM to about 2 mM, about 0.2 mM to about 1 mM, about 2 mM to about 50 mM, about 2 mM to about 30 mM, about 2 mM to about 20 mM, about 2 mM to about 10 mM, about 2 mM to about 4 mM, about 10 mM to about 50 mM, about 10 mM to about 30 mM, about 10 mM to about 20 mM, or about 30 mM to about 50 mM.

The present disclosure also includes a use of formamidine disulfide (FDS) for liberating a precious metal from a material, wherein the material comprises a sulfide encapsulating the precious metal; and wherein the material is contacted under acidic conditions with the FDS. The material is contacted with the FDS by any suitable method. In an embodiment, the material is contacted with the FDS by a method comprising: contacting the material with an acidic mixture comprising the FDS.

The concentration of the FDS in the acidic conditions can be any suitable concentration. The concentrations specified hereinbelow for FDS refer to a concentration calculated as if no FDS was dissociated into thiourea. In an embodiment, the FDS is present in the acidic conditions at a concentration of about 25 mM or lower. In another embodiment, the FDS is present in the acidic conditions at a concentration of about 15 mM or lower. In another embodiment, the FDS is present in the acidic conditions at a concentration of about 10 mM or lower. In some embodiments, a lower concentration of the FDS is used. Accordingly, in another embodiment, the FDS is present in the acidic conditions at a concentration of about 5 mM or lower, about 2.5 mM or lower, about 1 mM or lower, about 0.75 mM or lower, about 0.5 mM or lower, about 0.45 mM or lower, about 0.4 mM or lower, about 0.35 mM or lower, about 0.3 mM or lower, about 0.25 mM or lower, about 0.2 mM or lower, about 0.15 mM or lower, about 0.1 mM or lower, about 0.01 mM or lower, or about 0.001 mM. It will be appreciated by a person skilled in the art that such embodiments can be interchanged in any suitable manner. For example, in another embodiment, the FDS is present in the acidic conditions at a concentration of from about 0.001 mM to about 25 mM, about 0.001 mM to about 15 mM, about 0.001 mM to about 10 mM, about 0.001 mM to about 5 mM, about 0.001 mM to about 2.5 mM, about 0.001 mM to about 1 mM, about 0.001 mM to about 0.5 mM, about 0.001 mM to about 0.1 mM, about 0.001 mM to about 0.01 mM, about 0.01 mM to about 25 mM, about 0.01 mM to about 15 mM, about 0.01 mM to about 10 mM, about 0.01 mM to about 5 mM, about 0.01 mM to about 2.5 mM, about 0.01 mM to about 1 mM, about 0.01 mM to about 0.5 mM, about 0.01 mM to about 0.1 mM, about 0.1 mM to about 25 mM, about 0.1 mM to about 15 mM, about 0.1 mM to about 10 mM, about 0.1 mM to about 5 mM, about 0.1 mM to about 2.5 mM, about 0.1 mM to about 1 mM, about 0.1 mM to about 0.5 mM, about 1 mM to about 25 mM, about 1 mM to about 15 mM, about 1 mM to about 10 mM, about 1 mM to about 5 mM, about 1 mM to about 2 mM, about 5 mM to about 25 mM, about 5 mM to about 15 mM, about 5 mM to about 10 mM, or about 15 mM to about 25 mM.

In an embodiment, the material is agglomerated prior to contact. Methods for agglomerating are well known in the art and a suitable method for agglomeration can be selected by the skilled person.

In some embodiments, the acidic conditions further comprise an oxidizing agent. For example, in some embodiments, the acidic mixture further comprises an oxidizing agent. The oxidizing agent can be any suitable oxidizing agent or combination thereof, the selection of which can be made by a person skilled in the art. In an embodiment, the oxidizing agent comprises oxygen, a source of Fe³⁺ ions or combinations thereof. In another embodiment, the oxidizing agent comprises a source of Fe³⁺ (ferric) ions or iron. For example, the oxidizing agent can comprise a water-soluble salt such as ferric sulfate (also known as iron (III) sulfate or Fe₂(SO₄)₃) that can act as a direct source of Fe³ ions and/or a water-soluble salt such as ferrous sulfate (also known as iron (II) sulfate or FeSO₄) that acts as a direct source of Fe²⁺ ions that can, for example, be oxidized into Fe³⁺ ions e.g. by iron-oxidizing bacteria. In some embodiments, indirect sources of Fe³⁺ ions may also comprise suitable iron sludges. In another embodiment, the oxidizing agent comprises ferric sulfate. In another embodiment, the source of ferric ions comprises ferric ions generated at least in part by iron-oxidizing bacteria. In an embodiment, the acidic conditions or acidic mixture comprise a ferric solution. In another embodiment, the acidic conditions or acidic mixture comprise a ferric sulfate solution. In a further embodiment, the acidic conditions or acidic mixture comprise a ferric media. In another embodiment, the acidic conditions or acidic mixture comprise a ferrous sulfate solution. In another embodiment, the ferrous sulfate solution provides a source of Fe²⁺ ions that are oxidized to Fe³⁺ ions by iron-oxidizing bacteria. The concentration of the oxidizing agent such as ferric sulfate in the acidic conditions or acidic mixture can be any suitable concentration. In an embodiment, prior to the material being contacted with the reagent having the thiocarbonyl functional group, the oxidizing agent e.g. ferric sulfate is present in the acidic conditions or acidic mixture at a concentration of less than 10 g/L of Fe³⁺. In another embodiment, prior to the material being contacted with the reagent having the thiocarbonyl functional group, the oxidizing agent e.g. ferric sulfate is present in the acidic conditions or acidic mixture at a concentration of from about 0.5 g/L to about 20 g/L, about 1.5 g/L to about 3 g/L or about 2 g/L to about 2.5 g/L of Fe³⁺.

In some embodiments, during the contact, the method further comprises bio-oxidation of the material. The selection of suitable microbes for bio-oxidation can be made by a person skilled in the art. Suitable microbes are, for example, capable of oxidizing reduced forms of sulfur and similar species in the sulfide and optionally other species such as Fe²⁺ ions. Accordingly, in some embodiments, the material further comprises sulfur-oxidizing bacteria, iron-oxidizing bacteria, bacteria that are sulfur-oxidizing and iron-oxidizing or combinations thereof. In some embodiments, the sulfur-oxidizing bacteria, iron-oxidizing bacteria, bacteria that are sulfur-oxidizing and iron-oxidizing or combinations thereof are added to the acidic conditions, for example, the acidic mixture further comprises sulfur-oxidizing bacteria, iron-oxidizing bacteria, bacteria that are sulfur-oxidizing and iron-oxidizing or combinations thereof. In an embodiment, the bacteria are sulfur-oxidizing. In another embodiment, the bacteria are iron-oxidizing. In an embodiment, the bacteria are sulfur-oxidizing and iron-oxidizing. In an embodiment, the bacteria that are sulfur-oxidizing and iron-oxidizing comprise Acidothiobacilos ferrooxidans.

In an embodiment, the sulfide comprises a sulfide mineral. In some embodiments, the material comprising a sulfide is a material comprising a sulfide mineral. In some embodiments, the sulfide mineral is broken down by the oxidation of sulfides that is catalyzed by the reagent having the thiocarbonyl functional group. In an embodiment, the sulfide comprises sulfur, iron, arsenic, antimony or combinations thereof; i.e. it will be appreciated by the person skilled in the art that such species are in a suitable ionic form for the particular sulfide in which they are comprised. In an embodiment, sulfide comprises sulfur. In another embodiment, the sulfide comprises iron. In another embodiment, the sulfide comprises arsenic. In another embodiment, the sulfide comprises antimony. In another embodiment, the sulfide comprises pyrite, arsenian pyrite, marcasite, arsenopyrite, pyrrhotite, enargite, bornite, chalcopyrite or combinations thereof. In a further embodiment, the sulfide comprises pyrite. In another embodiment, the sulfide comprises arsenian pyrite. In another embodiment, the sulfide comprises marcasite. In another embodiment, the sulfide comprises arsenopyrite. In another embodiment, the sulfide comprises pyrrhotite. In another embodiment, the sulfide comprises enargite. In another embodiment, the sulfide comprises bornite. In another embodiment, the sulfide comprises chalcopyrite. In another embodiment, the sulfide comprises pyrite, arsenian pyrite, arsenopyrite, or combinations thereof.

In an embodiment, the precious metal comprises a platinum group metal, gold, silver or combinations thereof. In another embodiment, the precious metal comprises gold. In a further embodiment, the precious metal comprises silver. In another embodiment, the precious metal comprises a platinum group metal. In another embodiment, the precious metal comprises platinum. In another embodiment, the precious metal comprises gold, silver or combinations thereof. In another embodiment, the precious metal comprises a combination of gold and silver.

In an embodiment, the material further comprises a base metal. The base metal may be comprised in the sulfide, in another mineral or combination thereof in the material or combinations thereof. For example, suitable base metals may include but are not limited to copper, nickel, iron, aluminum, lead, zinc, tin, tungsten (also sometimes referred to as wolfram), molybdenum, tantalum, magnesium, cobalt, bismuth, cadmium, titanium, zirconium, antimony, manganese, beryllium, chromium, germanium, vanadium, gallium, hafnium, indium, niobium (also sometimes referred to as columbium), rhenium, thallium and combinations thereof. In an embodiment, the base metal comprises copper, nickel, zinc or combinations thereof. In another embodiment, the base metal comprises copper. In an embodiment, the base metal is comprised in a base metal sulfide ore. In an embodiment, the copper is comprised in a copper sulfide ore. In another embodiment, the copper sulfide ore is a primary copper sulfide (e.g. chalcopyrite, bornite, enargite or combinations thereof), a secondary copper sulfide (e.g. covellite, chalcocite or combinations thereof) or combinations thereof. In an embodiment, the copper sulfide ore comprises a primary copper sulfide. In another embodiment, the copper sulfide ore comprises a secondary copper sulfide. In a further embodiment, the copper sulfide ore comprises a combination of a primary copper sulfide and a secondary copper sulfide. In another embodiment, the copper sulfide ore comprises chalcopyrite, bornite, enargite, covellite, chalcocite, a copper sulfide of the formula CuₓS_{y} wherein the x:y ratio is between 1 and 2 or combinations thereof. In an embodiment, the copper sulfide of the formula CuₓS_{y} wherein the x:y ratio is between 1 and 2 is chalcocite, djurleite, digenite or combinations thereof. In another embodiment, the copper sulfide ore comprises chalcopyrite. Base metal sulfide ores other than copper sulfide ores are well known to the person skilled in the art. In an embodiment, the material comprises a nickel sulfide ore. In another embodiment, the nickel sulfide ore comprises pentlandite, violarite or combinations thereof.

The acidic conditions are any suitable acidic conditions, the selection of which can be made by a person skilled in the art. In some embodiments, an acid is added to obtain the acidic conditions. In another embodiment, the acid added to obtain the acidic conditions comprises sulfuric acid. In an embodiment, pH of the acidic conditions is in a range of from about 0 to about 6.5, about 0.5 to about 4, about 1 to about 3, or about 1.5 to about 2.5. In another embodiment, the pH of the acidic conditions is about 2.

The molar ratio of the reagent having the thiocarbonyl functional group to ferric (Fe³⁺) ions in the acidic mixture is any suitable ratio. In an embodiment, the molar ratio of the reagent having the thiocarbonyl functional group to ferric (Fe³⁺) ions is less than about 0.25.

The contacting can be carried out using any suitable method and/or means, the selection of which can be made by a person skilled in the art. In an embodiment, the contacting comprises a method comprising a percolation (e.g. in a heap, a dump or a column), a tank, a vat, a bioreactor or combinations thereof. In an embodiment, the contacting comprises a method comprising a percolation (e.g. in a heap, a dump or a column), a tank, a vat or combinations thereof. In another embodiment, the method comprising a percolation is a method comprising a heap or a dump. In an embodiment, the contacting comprises a method comprising a percolation. In another embodiment, the contacting comprises a method comprising a heap. In another embodiment, the contacting comprises a method comprising a dump. In another embodiment, the contacting comprises a method comprising a column. In another embodiment, the contacting comprises a method comprising a tank. In another embodiment, the contacting comprises a method comprising a vat. In another embodiment, the contacting comprises a method comprising a bioreactor. Suitable methods, means and/or conditions for carrying out the contacting in a percolation (e.g. in a heap, a dump or a column), a tank, a vat or a bioreactor in the methods of the present disclosure can be selected by the person skilled in the art.

In an embodiment, the contacting produces a residue comprising the precious metal. In another embodiment, subsequent to contact, the method further comprises pressure oxidation to produce a residue comprising the precious metal.

In some embodiments, the use further comprises leaching the precious metal from the residue comprising the precious metal so as to extract the precious metal from the material.

Accordingly, the present disclosure also includes a use of a reagent having a thiocarbonyl functional group or formamidine disulfide (FDS), as the case may be, in a method for extracting a precious metal from a material comprising a sulfide encapsulating the precious metal, the method comprising a method as described herein for liberating a precious metal from a material, wherein the material comprises a sulfide encapsulating the precious metal, the method comprising contacting the material under acidic conditions with a reagent having a thiocarbonyl functional group wherein the contacting produces a residue comprising the precious metal; and leaching the precious metal from the residue comprising the precious metal.

The leaching can comprise any suitable method and/or means for leaching the precious metal from the residue, the selection of which can be made by the person skilled in the art. In an embodiment, the leaching comprises contacting the residue with a lixiviant to extract the precious metal from the residue. It will be appreciated by a person skilled in the art that a suitable lixiviant may, for example, depend on the identity of the precious metal and/or other components (e.g. base metals) in the material and the skilled person can readily select a suitable lixiviant accordingly. In an embodiment, the lixiviant comprises cyanide, thiosulfate, glycine, thiocyanate, chloride, a reagent having a thiocarbonyl functional group or iodine/iodide. In another embodiment, the leaching comprises cyanidation. In a further embodiment, the lixiviant comprises a reagent having a thiocarbonyl functional group. In an embodiment, the leaching comprises a percolation leach (e.g. a heap leach, a dump leach or a column leach), a tank leach, a vat leach, a bioreactor or combinations thereof. In an embodiment, the leaching comprises a percolation leach (e.g. a heap leach, a dump leach or a column leach), a tank leach, a vat leach or combinations thereof. In another embodiment, the percolation leach is a heap leach or a dump leach. In an embodiment, the leaching comprises a percolation leach. In another embodiment, the leaching comprises a heap leach. In another embodiment, the leaching comprises a dump leach. In another embodiment, the leaching comprises a column leach. In another embodiment, the leaching comprises a tank leach. In another embodiment, the leaching comprises a vat leach. In another embodiment, the leaching comprises a bioreactor. Suitable methods, means and/or conditions for carrying out the leaching in a percolation leach (e.g. in a heap leach, a dump leach or a column leach), a tank leach, a vat leach or a bioreactor in the uses of the present disclosure can be selected by the person skilled in the art.

In some embodiments, the contacting and the leaching are carried out using the same means; for example, the contact is carried out in a method comprising a heap and the leaching comprises a heap leach. In alternative embodiments, the contacting and the leaching are carried out using different means; for example, the contact is carried out in a method comprising a heap and the leaching comprises a tank leach. Any suitable combination of means as described herein can be used and selected by the person skilled in the art.

In an embodiment, prior to leaching, the use further comprises washing the residue comprising the precious metal.

In an embodiment, the use further comprises recovering the precious metal. In another embodiment, the leaching produces a pregnant leach solution comprising the precious metal. In an embodiment, the leaching produces a pregnant leach solution comprising the precious metal and the use further comprises recovering the precious metal from the pregnant leach solution. In embodiments wherein the use comprises recovering the precious metal (e.g. from the pregnant leach solution), the method for recovering the precious metal can be any suitable method, the selection of which can be made by the person skilled in the art. It will be appreciated by a person skilled in the art that methods for recovery of the precious metal may depend, for example, on the method used for leaching and/or the nature of the precious metal(s) being recovered and can readily select a suitable means and/or method for recovery of the precious metal. In an embodiment, the recovering comprises cementation, ion exchange, adsorption of the precious metal on carbon, reduction of the precious metal with a reducing agent, solvent extraction or recovering, electrowinning or combinations thereof. In an embodiment, the cementation comprises Merrill-Crowe precipitation (zinc dust cementation). In an embodiment, the adsorption of the precious metal is on activated carbon or charcoal. In another embodiment, prior to the recovering, the method further comprises a solid-liquid separation.

In another embodiment, the use further comprises recovering the reagent having the thiocarbonyl functional group or the FDS, as the case may be. For example, the reagent having the thiocarbonyl functional group or the FDS can be recovered subsequent to contact with the material and/or in embodiments wherein the leaching comprises use of a reagent having a thiocarbonyl functional group, the reagent having the thiocarbonyl functional group can be recovered from the pregnant leach solution. In some embodiments, the use optionally further comprises recycling the recovered reagent having the thiocarbonyl functional group or the FDS for use in the contacting of a further portion of the material and/or for use in leaching such as for use in contacting with a further portion of the residue, as the case may be. In some embodiments, additional reagent having a thiocarbonyl functional group (or dimer thereof) is added to reach a desired concentration prior to the contacting with the material and/or prior to the leaching. In some embodiments, a reducing agent is added prior to the contacting with the material and/or prior to the leaching. In an embodiment, the reducing agent may be, for example, H₂S, NaSH or Zn. In an embodiment, the reducing agent is added in an amount to obtain a ratio of reagent having a thiocarbonyl functional group (e.g. thiourea):corresponding dimer (e.g. FDS) in a range of about 0.5:1 to about 9:1.

The contacting is carried out under any suitable temperature and pressure conditions. For example, the contacting can be carried out at a temperature greater than 0° C. to about 80° C. However, the contacting in the uses of the present disclosure is advantageously carried out at ambient temperature (e.g. from about 5° C. to about 55° C. or about 15° C. to about 25° C.) and pressure (e.g. about 1 atm). In an embodiment, the contact is at ambient temperature and pressure. In another embodiment, the contact is at ambient temperature. In another embodiment, the contact is at ambient pressure. The leaching is also carried out under any suitable temperature and pressure conditions, the selection of which can be made by a person skilled in the art.

In an embodiment, the use is a batch use.

In an embodiment, the use is a continuous use.

The following non-limiting examples are illustrative of the present disclosure:

### EXAMPLES

The general pre-treatment conditions used in the examples were 4.4 g/L Fe³⁺ from ferric sulfate (Fe₂(SO₄)₃) adjusted by sulfuric acid to a pH around 2 for all experiments. The specified amounts of minerals and thiocarbonyl compounds were added to the pre-treatment solution. Acidithiobacillus ferrooxidans, an iron- and sulfur-oxidizing bacterium, was incorporated into the pre-treatment environment. Bacteria were cultured from Modified Kelly Medium (MKM; containing 0.4 g/L ammonium sulfate, 0.4 g/L magnesium sulfate and 0.04 g/L potassium dihydrogen phosphate). The same bacterial culture was used in all bioleaching tests. 1 ml/L of the culture was added to each bioreactor containing 4.4 g/L total iron before the test and no further maintenance was performed. The (oxidation reduction potential (ORP) of all bioreactors was monitored until it stabilized at >700 mV vs an Ag/AgCl reference electrode, indicating that bacteria were active as they oxidized ferrous into ferric. The minerals were added after that and were agitated in bioreactors at about 500 rpm under ambient temperature and atmosphere.

### Example 1

Example 1 used an agitated bioreactor and demonstrates the catalytic effect of thiocarbonyl compounds on the oxidation of sulfides in refractory gold deposits. The mineral sample was a tailing containing 0.51 g/t gold, 35 g/t silver, 0.1% copper and 0.12% arsenic according to chemical assay. The quantitative x-ray diffraction (QXRD) analysis of the composition is shown in Table 1 with 8.1% of pyrite and no arsenopyrite in the sample. It suggests that the arsenic is likely substituted into the pyrite structure as arsenian pyrite.

TABLE 1

| Mineral | Formula | % |
|---|---|---|
| Calcite | CaCO₃ | 0.9 |
| Clinochlore | (Mg, Fe²⁺)₅Al(Si₃Al)O₁₀(OH)₈ | 1.8 |
| Dolomite | CaMg(CO₃)₂ | 0.7 |
| Gypsum | CaSO₄•2H₂O | 1.0 |
| Illite - Muscovite 2M1 | K_{0.65}Al_{2.0}Al_{0.65}Si_{3.35}O₁₀(OH)₂—KAl₂(AlSi₃O₁₀)(OH)₂ | 26.2 |
| Illite - Muscovite 1M | K_{0.65}Al_{2.0}Al_{0.65}Si_{3.35}O₁₀(OH)₂—KAl₂(AlSi₃O₁₀)(OH)₂ | 7.4 |
| K-feldspar (Orthoclase) | KAlSi₃O₈ | 2.6 |
| Magnetite | Fe₃O₄ | 0.7 |
| Plagioclase (Albite) | NaAlSi₃O₈—CaAl₂Si₂O₈ | 9.6 |
| Pyrite | FeS₂ | 8.1 |
| Quartz | SiO₂ | 37.3 |
| Rutile | TiO₂ | 1.5 |
| Sillimanite | Al₂SiO₅ | 2.3 |
| Total | | 100.1 |

In all tests, 200 g of tailings were used in a 2 L bioreactor. A control test (“Control”) was carried out using the general conditions described above for 10 days. A test with thiourea (“Tu”) was run under the same conditions as the control test, except for the addition of 0.2 mM Tu per day. In this example, the cumulative thiocarbonyl to ferric mole ratio was 0.025.

After 10 days of pre-treatment, solid residues from both reactors were collected by filtration followed by rinsing. 100 g of the sample was taken from each residue for cyanidation processing with the rest analyzed by chemical assay. For the cyanidation, 100 g of the dry residue and 400 mL deionized water were added to a glass reactor. The reactor was covered by a polyethylene lid with a pH meter mounted on top. An overhead agitator was used to provide mixing at a speed of 500 rpm. The retention time for cyanidation tests was 24 hours. The concentration of the leaching reagent was 1 g/L sodium cyanide. Before adding sodium cyanide, the pH of the slurry was adjusted to 11 by adding calcium hydroxide. After 24 hours, the leaching was stopped. Solid and liquid were separated by filtration. The filtered residue was washed with deionized water and air dried. Both filtrate and residue were sent for chemical assay.

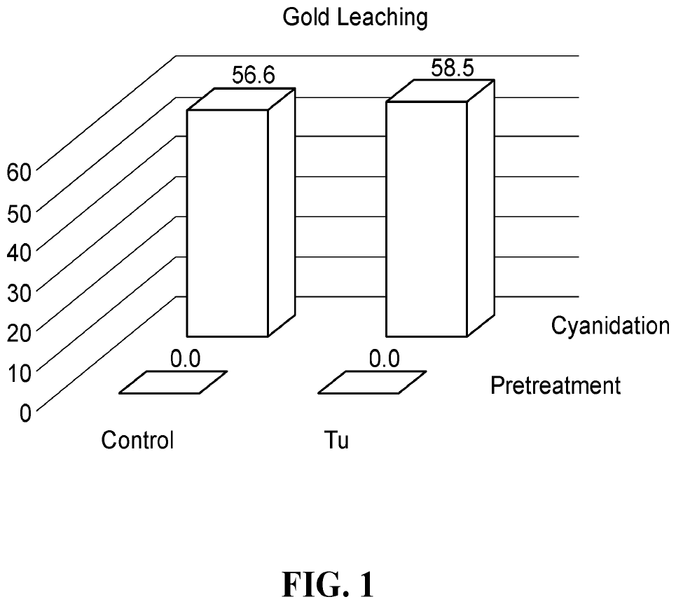

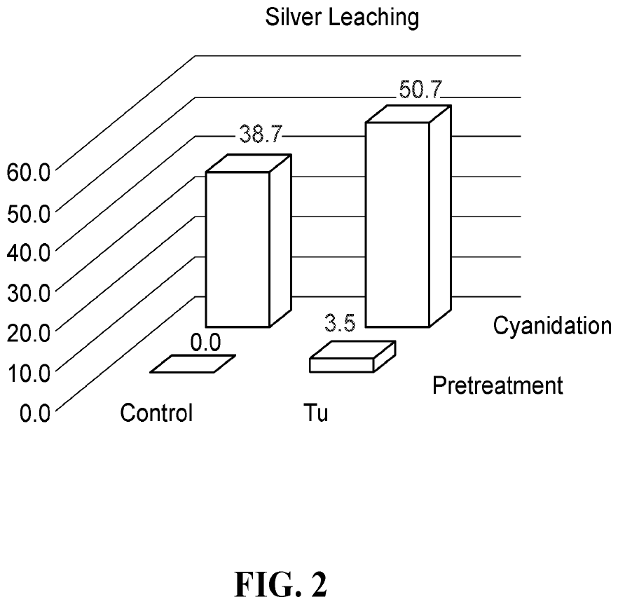

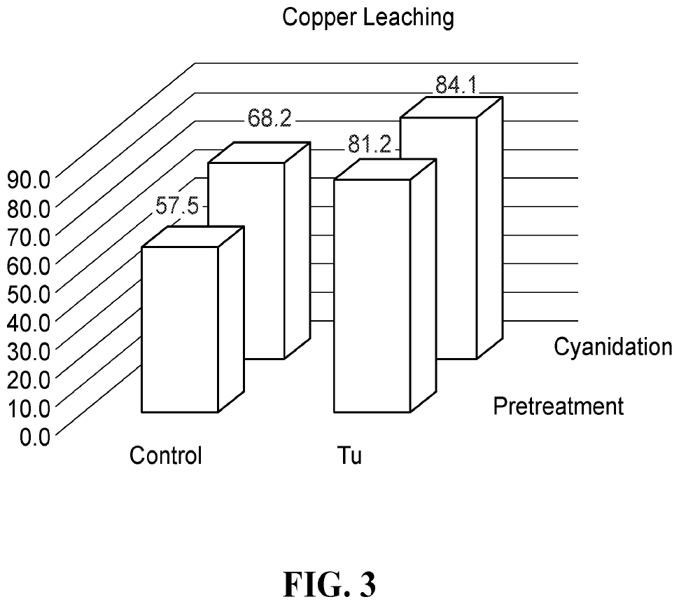

The results of gold, silver and copper extraction after the pre-treatment and subsequent cyanidation are shown in FIG. 1 (gold), FIG. 2 (silver) and FIG. 3 (copper). Copper was leached under control conditions (57.5%) and even more under Tu catalyzed conditions (81.2%). On the other hand, in the pre-treatment method, gold was not leached under the control conditions. The addition of 0.2 mM Tu per day also did not leach gold from the ore within a 10-day period. This is advantageous for the method as the pre-treatment oxidized sulfide, but did not extract or leach any detectable amount of gold. The presence of solubilized silver was an unintended side effect due to the formation of silver-thiourea complexes following precious metal liberation and can be mitigated by adjusting thiocarbonyl concentration and/or using an ion-exchange resin to recover the silver solubilized at this stage.

For a cyanidation method where metals are extracted, it was found that Tu pre-treatment enhances the gold, silver and copper recovery from 56.6%, 38.7% and 68.2% to 58.5%, 50.7% and 84.1%, respectively. The results show that adding a thiocarbonyl catalyst such as Tu, to the bio-oxidation pre-treatment has a beneficial effect on the recovery of all of these metals in the subsequent cyanidation method.

### Example 2

Example 2 used an agitated bioreactor and demonstrates the catalytic effect of thiocarbonyl compounds on the oxidation of sulfides in pure arsenopyrite. A pulverized pure arsenopyrite mineral sample was used in the tests. Thiourea and the same Acidithiobacillus ferrooxidans bacteria stream used in Example 1 were also used in these tests. In all tests, 10 g of arsenopyrite was used in a 2-L bioreactor. A control test (“Control”) was carried out using the general conditions described above for 14 days. A test with thiourea (“Tu”) was run under the same conditions as the control test, except for the addition of 2 mM Tu in total. The addition of 2 mM Tu was separated into 10 steps throughout the period with 0.2 mM Tu added at each step. In this example, the cumulative thiocarbonyl to ferric mole ratio was 0.05.

For pyrite and arsenopyrite, two of the possible oxidation reactions are as follows:

$${FeS}_{2} + 8 {H}_{2} O + 14 {Fe}^{3 +} \to 15 {Fe}^{2 +} + 2 {SO}_{{4}^{2 -}} + 16 {H}^{+}$$

$$FeAsS + 5 {Fe}^{3 +} \to {As}^{3 +} + 6 {Fe}^{2 +} + {S}^{0}$$

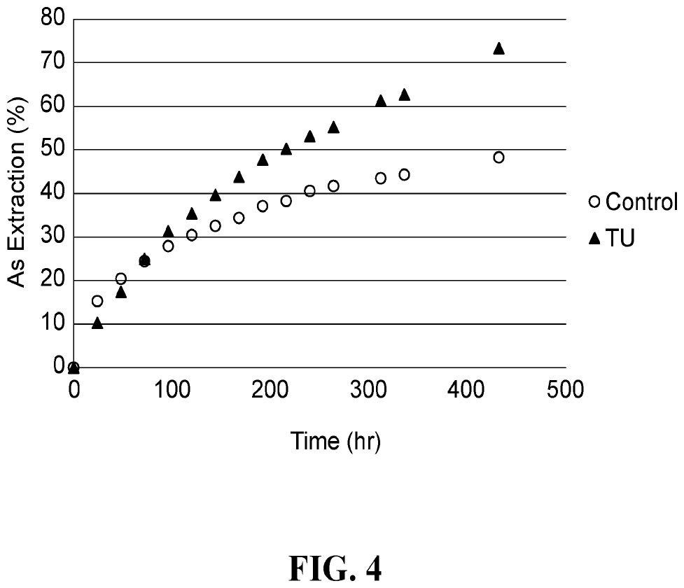

For conditions wherein the acidic conditions have a high concentration of iron, it can be less reliable to use iron concentration to indicate the extent of sulfide oxidation. Therefore, arsenic concentration can be used instead as an indicator to monitor the extent of mineral breakdown and sulfide oxidation. After 432 hours of pre-treatment, the Control test released only 48.27% of the arsenic whereas the Tu test released 73.33% of the arsenic (FIG. 4).

While the disclosure has been described with reference to what are presently considered to be the preferred examples, it is to be understood that the disclosure is not limited to the disclosed examples. To the contrary, the present disclosure is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

1. A method for liberating a precious metal from a material, the method comprising:
contacting the material under acidic conditions with a reagent comprising a thiocarbonyl functional group, wherein the material comprises a sulfide encapsulating the precious metal.

2. The method of claim 1, wherein the reagent comprising the thiocarbonyl functional group comprises a monomer of the reagent.

3. The method of claim 1, wherein the reagent comprising the thiocarbonyl functional group is not thiourea.

4. The method of claim 1, wherein the reagent comprising the thiocarbonyl functional group comprises N—N′ substituted thioureas; 2,5-dithiobiurea; dithiobiuret; thiosemicarbazide purum; thiosemicarbazide; thioacetamide; 2-methyl-3-thiosemicarbazide; 4-methyl-3-thiosemicarbazide; vinylene trithiocarbonate purum; vinylene trithiocarbonate; 2-cyanothioacetamide; ethylene trithiocarbonate; potassium ethyl xanthogenate; dimethylthiocarbamoyl chloride; dimethyldithiocarbamate; dimethyl trithiocarbonate; N,N-dimethylthioformamide; 4,4-dimethyl-3-thiosemicarbazide; 4-ethyl-3-thiosemicarbazide; O-isopropylxanthic acid; ethyl thiooxamate; ethyl dithioacetate; pyrazine-2-thiocarboxamide; diethylthiocarbamoyl chloride; diethyldithiocarbamate; tetramethylthiuram monosulfide; tetramethylthiuram disulfide; pentafluorophenyl chlorothionoformate; 4-fluorophenyl chlorothionoformate; O-phenyl chlorothionoformate; phenyl chlorodithioformate; 3,4-difluorothiobenzamide; 2-bromothiobenzamide; 3-bromothiobenzamide; 4-bromothiobenzamide; 4-chlorothiobenzamide; 4-fluorothiobenzamide; thiobenzoic acid; thiobenzamide; 4-phenylthiosemicarbazide; O-(p-tolyl) chlorothionoformate; 4-bromo-2-methylthiobenzamide; 3-methoxythiobenzamide; 4-methoxythiobenzamide; 4-methylbenzenethioamide; thioacetanilide; salicylaldehyde thiosemicarbazone; indole-3-thiocarboxamide; S-(thiobenzoyl)thioglycolic acid; 3-(acetoxy)thiobenzamide; 4-(acetoxy)thiobenzamide; methyl N′-[(e)-(4-chlorophenyl)methylidene]hydrazonothiocarbamate; 3-ethoxythiobenzamide; 4-ethylbenzene-1-thiocarboxamide; tert-butyl 3-[(methylsulfonyl)oxy]-1-azetanecarboxylate; diethyldithiocarbamic acid; 2-(phenylcarbonothioylthio)propanoic acid; 2-hydroxybenzaldehyde N-ethylthiosemicarbazone; (1R,4R)-1,7,7-trimethylbicyclo[2.2.1]heptane-2-thione; tetraethylthiuram disulfide; 4′-hydroxybiphenyl-4-thiocarboxamide; 4-biphenylthioamide; dithizone; 4′-methylbiphenyl-4-thiocarboxamide; tetraisopropylthiuram disulfide; anthracene-9-thiocarboxamide; phenanthrene-9-thiocarboxamide; sodium dibenzyldithiocarbamate; 4,4′-bis(dimethylamino)thiobenzophenone; or any combination thereof.

5. The method of claim 1, wherein the reagent comprising the thiocarbonyl functional group comprises thiourea.

6. The method of claim 1, wherein the reagent comprising the thiocarbonyl functional group is added in the form of the corresponding dimer.

7. The method of claim 1, wherein the reagent comprising the thiocarbonyl functional group comprises thioacetamide (TA).

8. The method of claim 1, wherein the reagent comprising the thiocarbonyl functional group comprises sodium-dimethyldithiocarbamate (SDDC).

9. The method of claim 1, wherein the reagent comprising the thiocarbonyl functional group comprises ethylene trithiocarbonate (ETC).

10. The method of claim 1, wherein the reagent comprising the thiocarbonyl functional group comprises thiosemicarbazide (TSCA).

11. The method of claim 1, wherein the reagent comprising the thiocarbonyl functional group is at a concentration of about 50 mM or lower.

12. The method of claim 1, wherein the reagent comprising the thiocarbonyl functional group is at a concentration of about 0.002 mM to about 50 mM.

13. The method of claim 1, wherein the reagent comprising the thiocarbonyl functional group is at a concentration of about 0.002 mM to about 30 mM.

14. The method of claim 1, wherein the reagent comprising the thiocarbonyl functional group is at a concentration of about 0.002 mM to about 20 mM.

15. The method of claim 1, wherein the reagent comprising the thiocarbonyl functional group is at a concentration of about 0.002 mM to about 5 mM.

16. The method of claim 1, wherein the reagent comprising the thiocarbonyl functional group is at a concentration of about 0.002 mM to about 2 mM.

17. The method of claim 1, wherein the reagent comprising the thiocarbonyl functional group is at a concentration of about 0.002 mM to about 0.2 mM.

18. The method of claim 1, wherein the reagent comprising the thiocarbonyl functional group is at a concentration of about 0.002 mM to about 0.02 mM.

19. A method for liberating a precious metal from a material, the method comprising:
contacting the material under acidic conditions with formamidine disulfide (FDS), wherein the material comprises a sulfide encapsulating the precious metal.

20. The method of claim 19, wherein the FDS is at a concentration of about 25 mM or lower.

21. The method of claim 19, wherein the FDS is at a concentration of about 0.001 mM to about 25 mM.

22. The method of claim 19, wherein the FDS is at a concentration of about 0.001 mM to about 15 mM.

23. The method of claim 19, wherein the FDS is at a concentration of about 0.001 mM to about 10 mM.

24. The method of claim 19, wherein the FDS is at a concentration of about 0.001 mM to about 2.5 mM.

25. The method of claim 19, wherein the FDS is at a concentration of about 0.001 mM to about 1 mM.

26. The method of claim 19, wherein the FDS is at a concentration of about 0.001 mM to about 0.1 mM.

27. The method of claim 19, wherein the FDS is at a concentration of about 0.001 mM to about 0.01 mM.

28. The method of claim 1, wherein the acidic conditions further comprise an oxidizing agent.

29. The method of claim 28, wherein the oxidizing agent comprises oxygen.

30. The method of claim 28, wherein the oxidizing agent comprises a source of Fe³⁺ (ferric) ions.

31. The method of claim 1, comprising bio-oxidation of the material.

32. The method of claim 31, wherein the material further comprises oxidizing bacteria.

33. The method of claim 30, wherein the acidic conditions further comprises oxidizing bacteria.

34. The method of claim 1, wherein the contacting produces a residue comprising the precious metal.

35. The method of claim 1, further comprising pressure oxidation to produce a residue comprising the precious metal.

36. The method of claim 34, further comprising contacting the residue with a lixiviant.

37. The method of claim 1, further comprising a leach.

38. The method of claim 37, wherein the leaching comprises a percolation leach, a tank leach, a vat leach, or a combination thereof.

39. The method of claim 1, further comprising recovering the precious metal.

40. The method of claim 39, wherein the recovering comprises cementation, ion exchange, adsorption of the precious metal on carbon, reduction of the precious metal with a reducing agent, solvent extraction or recovering, electrowinning or combinations thereof.

41. The method of claim 1, further comprising a solid-liquid separation.

42. The method of claim 1, further comprising recovering the reagent comprising the thiocarbonyl functional group or the FDS.

43. The method of claim 1, wherein the sulfide encapsulating the precious metal comprises a base metal sulfide.

44. The method of claim 19, further comprising recovering the reagent comprising the FDS.
